(19) United States
(12) Patent Application Publication
(10) Pub. No.: US 2016/0085744 A1
(43) Pub. Date: Mar. 24, 2016

(54) SYSTEM AND COMPUTER PROGRAM PRODUCT FOR COLLECTIVELY GATHERING RELIABLE FACTS AND VALIDATION THEREOF

(71) Applicant: François DUNN, Montreal (CA)

(72) Inventor: François DUNN, Montreal (CA)

(21) Appl. No.: 14/956,871

(22) Filed: Dec. 2, 2015

Related U.S. Application Data
(63) Continuation-in-part of application No. 14/730,675, filed on Jun. 4, 2015.
(60) Provisional application No. 62/008,838, filed on Jun. 6, 2014.

(51) Int. Cl. G06F 17/27; G06Q 20/10; G07C 13/00

(52) U.S. Cl. CPC G06F 17/2785; G06F 17/2775; G07C 13/00; G06Q 20/10

(57) ABSTRACT

The present disclosure relates to a system and a computer program product for collectively gathering reliable facts. The system receives a statement, at least one evidence related to the statement, and at least one validity indicator for the at least one evidence. The system assesses a reliability value of the at least one evidence using the at least one corresponding validity indicator. The system further determines a confidence indicator for the statement based on the at least one evidence and the corresponding reliability value. The computer program product comprises instructions which when executed by a processor of a computing device display a statement and an evidence received from the server on a display of the computing device. The instructions when executed also collect one of a validity indicator of the displayed evidence or a new evidence related to the displayed statement, which are transmitted to the server.

### CROSS-REFERENCES

The present application is a continuation in part of, and claims priority under 35 U.S.C. 120 to, U.S. patent application Ser. No. 14/730,675, filed on Jun. 4, 2015, entitled SYSTEM AND COMPUTER PROGRAM PRODUCT FOR COLLECTIVELY GATHERING RELIABLE FACTS AND VALIDATION THEREOF, which is incorporated herein by reference, and which is a nonprovisional of and claims priority under 35. U.S.C. 119(e) to U.S. provisional patent application 62/008,838, filed on Jun. 6, 2014, entitled SYSTEM AND COMPUTER PROGRAM PRODUCT FOR COLLECTIVELY GATHERING RELIABLE FACTS.

### TECHNICAL FIELD

The present disclosure relates to the field of collaborative information gathering and validation thereof. More specifically, the present disclosure relates to a system and computer program product for collectively gathering reliable facts.

### BACKGROUND

Collaborative information gathering via the Internet allows a multitude of users to share their knowledge on a multitude of topics, via a centralized on-line collaborative tool. For instance, Wikipedia is a collaborative on-line encyclopedia, which consists of a website having a plurality of sections, each section addressing a specific topic. Each section can be updated by users who may add, remove or modify information related to the section.

One critical issue with such on-line collaborative tools is the accuracy of the information provided by participating users. Fact checking may be self-organized, relying on the collaboration between participating users to converge to an accurate information for each topic addressed via the on-line collaborative tool. Alternatively or complementarily, a team of moderators may perform fact checking. However, with on-line collaborative tools such as Wikipedia, the amount of information to be verified makes it almost impossible to rely exclusively on a team of moderators.

One way to facilitate fact checking is to provide references (e.g. in the form of hyperlinks to sections of web sites) in support of the information provided by a contributor. However, the provision of references is often on a voluntary basis, and is not systematically integrated in the fact checking process implemented by the on-line collaborative tool.

Another way to facilitate fact checking is to provide the ability for visitors of the on-line collaborative tool to vote on a relevance of the information provided by a contributor. Some on-line collaborative tools have implemented such a voting process, but the voting process is generally limited to the validation of the information provided by contributors. Visitors do not have the capability to vote on additional aspects, such as the relevance of the topics addressed.

Thus, existing on-line collaborative tools each have strengths and weaknesses in terms of validation of the information provided by contributors, and in terms of the level of collaboration offered to contributors and visitors. Therefore, there is a need for a new system and computer program product for implementing an on-line collaborative tool capable of collectively gathering reliable facts.

### SUMMARY

According to a first aspect, the present disclosure provides a system for collectively gathering reliable facts. The system comprises a memory. The system also comprises a communication interface for receiving a statement, receiving an evidence related to the statement, and receiving at least one validity indicator for the evidence. The system further comprises a processing unit. The processing unit creates a factual record for the statement and stores the factual record in the memory. The factual record comprises the statement, the evidence and the at least one validity indicator for the evidence. The processing unit assesses a reliability value of the evidence using the at least one corresponding validity indicator. The processing unit determines a confidence indicator for the statement based on the evidence and the corresponding reliability value. The processing unit updates the factual record with the reliability value of the evidence and the confidence indicator of the statement.

According to another aspect, the present disclosure provides a computer program product deliverable via an electronically-readable media such as storage media and communication links. The computer program product comprises instructions which when executed by a processor of a computing device provide for collectively validating facts. Executing the instructions comprises receiving from a server a factual record. The factual record includes a statement and an evidence related to the statement. Executing the instructions comprises displaying the statement and the evidence on a display of the computing device. Executing the instructions comprises receiving via a user interface of the computing device one of the following: a validity indicator for the evidence or a new evidence related to the statement. Executing the instructions comprises transmitting to the server one of the following: the validity indicator for the evidence or the new evidence related to the statement.

### BRIEF DESCRIPTION OF THE DRAWINGS

Embodiments of the disclosure will be described by way of example only with reference to the accompanying drawings, in which:

FIG. 1 illustrates a schematic representation of relationships between elements of a factual record;

FIG. 2 illustrates a computing device for collectively validating facts;

FIGS. 3A-E illustrate a Graphical User Interface (GUI) of the computing device of FIG. 2.

FIGS. 4A and 4B illustrate steps of a method for collectively gathering reliable facts; and

FIG. 5 illustrates a server for collectively gathering reliable facts.

FIG. 6 is a schematic view of a computer system in accordance with at least an embodiment of the invention;

FIG. 7 is a flow chart illustrating the prior art and how an interested party may fabricate a statement that is favorable to itself and pay an information provider to give this statement more visibility in order to favorably influence potential business and marketing opportunities and potential economical gains while influencing the rating of the statement so it remains favorable and potentially unchallenged;

FIG. 8 is a flow chart illustrating how the high reliability value of the evidences supporting a statement will in turn translate into a high confidence indicator for said statement and then creates an interest for an interested party to take advantage of the high confidence indicator in accordance with at least an embodiment of the invention;

FIG. 9 is a flow chart illustrating the economical interest for an interested party to pay to increase the visibility of a profitable statement in accordance with at least an embodiment of the invention;

FIG. 10 is flow chart illustrating that an interested party pays to submit a statement with the claimed method in accordance with at least an embodiment of the invention;

FIG. 11 is a flow chart illustrating that an interested party pays to increase the visibility of a favorable statement in accordance with at least an embodiment of the invention;

FIG. 12 is a flow chart illustrating that the claimed method to calculate the confidence indicator of a statement cannot be influenced by an interested party and the said confidence indicator creates an interest to pay to increase the visibility of said statement in accordance with at least an embodiment of the invention;

FIG. 13 is a flow chart illustrating the link between a statement and its confidence indicator, the components and the method used to calculate the statement's confidence indicator in accordance with at least an embodiment of the invention;

FIG. 14 is a flow chart illustrating the validity indicators used to calculate the reliability value of the submitted statement in accordance with at least an embodiment of the invention;

FIG. 15 is a flow chart illustrating the validity indicators used to calculate the reliability value of the validation of the statement in accordance with at least an embodiment of the invention;

FIG. 16 is a flow chart illustrating the components used to calculate a validity indicator, based on the rating of the content of the submitted statement to calculate the reliability value of the submitted statement in accordance with at least an embodiment of the invention;

FIG. 17 is a flow chart illustrating the components used to calculate a validity indicator, based on the rating of the content of the validation of the statement, which is used to calculate the reliability value of the validation of a statement in accordance with at least an embodiment of the invention;

FIG. 18 is a flow chart illustrating the components to calculate a validity indicator based on the number of times the submitted statement is shared in accordance with at least an embodiment of the invention;

FIG. 19 is a flow chart illustrating the components to calculate a validity indicator based on the number of times the submitted statement is viewed in accordance with at least an embodiment of the invention;

FIG. 20 is a flow chart illustrating the components to calculate the validity indicator based on the number of comments made on the submitted statement in accordance with at least an embodiment of the invention;

FIG. 21 is a flow chart illustrating the components to calculate the validity indicator based on the moderator's vote received in support of the submitted statement in accordance with at least an embodiment of the invention;

FIG. 22 is a flow chart illustrating the components to calculate the validity indicator based on the moderator's vote received in support of the validation of the statement in accordance with at least an embodiment of the invention;

FIG. 23 is a flow chart illustrating the components to calculate the validity indicator based on a statement's author's reactivity to non-compliant comments and alerts made on a statement in accordance with at least an embodiment of the invention;

FIG. 24 is a flow chart illustrating the interaction between the calculation of a statement's confidence indicator, the resulting potential economical interest and increased interest for an interested party to pay for an increased visibility for said statement and the inability for the interested party to influence the confidence indicator's calculation with the claimed method in accordance with at least an embodiment of the invention;

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address one or more of the problems related to collective gathering of reliable facts.

### DEFINITIONS

Fact: a thing that is indisputably the case, verifiable from experience of observation, also used to refer to an objective piece of information used as evidence or as part of a report or news article;

Statement: definite or clear expression of something in speech or writing that could be an assertion or an account of facts, views or plans;

Evidence: available body of information indicating whether a statement is true and/or valid;

Gathering: bring together and take in from scattered places or sources.

Validity: the quality of being logically or factually sound, and/or the state of being rationally, plausibly, legally or officially binding or acceptable;

Reliability: the quality of being based on information which can be trusted or verified;

Assessing: evaluate or estimate the nature, worth, ability or quality;

Confidence: state of feeling certain about the truth of something, also used to refer to the feeling or belief that one can rely on something;

Determining: ascertain or establish exactly, typically as a result of research or calculation;

Factual record: a set of information (e.g. statement, evidence, validity indicator, reliability value, confidence indicator, etc.) related to the collective gathering and validation of facts. The information of the factual record evolves along the process of gathering and validating facts.

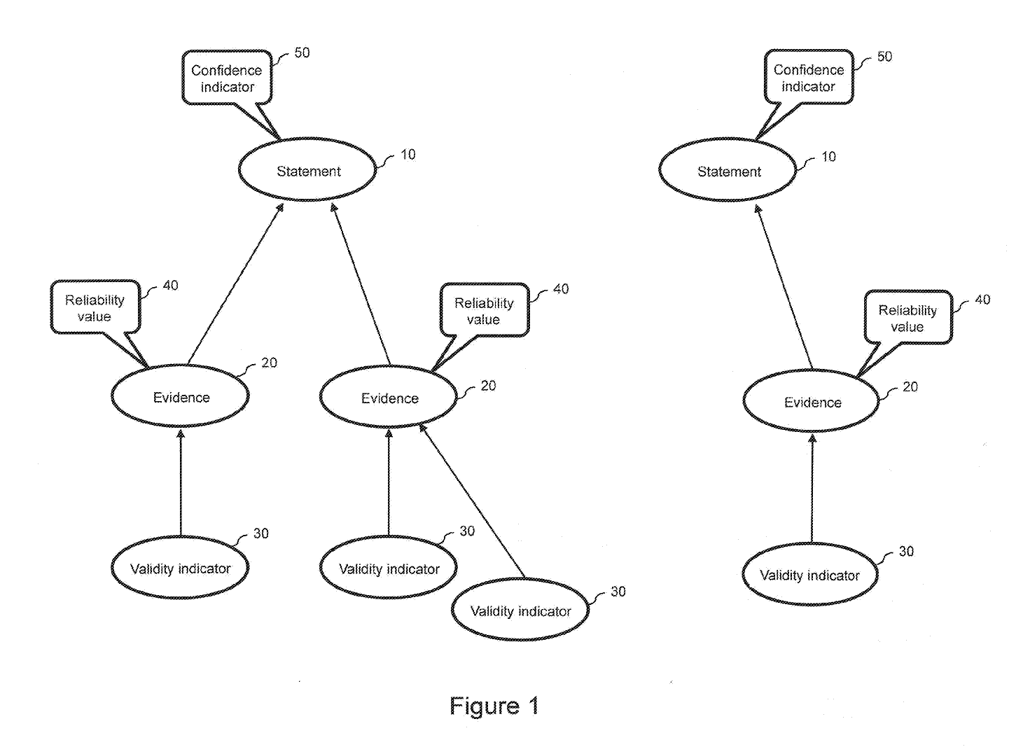

Referring now to FIG. 1, a schematic representation of relationships between elements of a factual record in a system for collectively gathering reliable facts is represented.

FIG. 1 illustrates that one or more statements 10 can be evaluated by the system. For each specific statement 10, one or more evidences 20 related to the specific statement 10 can be provided by a community of contributors. For each specific evidence 20, one or more validity indicators 30 can be provided. Several types of validity indicators 30 may be available. For instance, a first type of validity indicator 30 may consist of a plurality of votes provided by the community of contributors. A second type of validity indicator 30 may be provided by a pre-defined person (or group of persons), such as a moderator or a skilled person in the field related to the statement 10. For each specific evidence 20, a corresponding reliability value 40 can be assessed based on the validity indicator(s) associated to the specific evidence 20. For each specific statement 10, a corresponding confidence indicator 50 can be determined, based on the evidence(s) 20 associated to the specific statement 10 and on the corresponding reliability value(s) 40.

A factual record (not represented in FIG. 1) includes data related to a particular statement 10. As will be detailed later in the description, the data included in a particular factual record evolve over time, and may include the particular statement 10, a confidence indicator 50 of the particular statement 10, one or more evidence(s) 20 related to the particular statement 10, one or more reliability value(s) 40 associated to the evidence(s) 20, and one or more validity indicator(s) 30 per evidence 20.

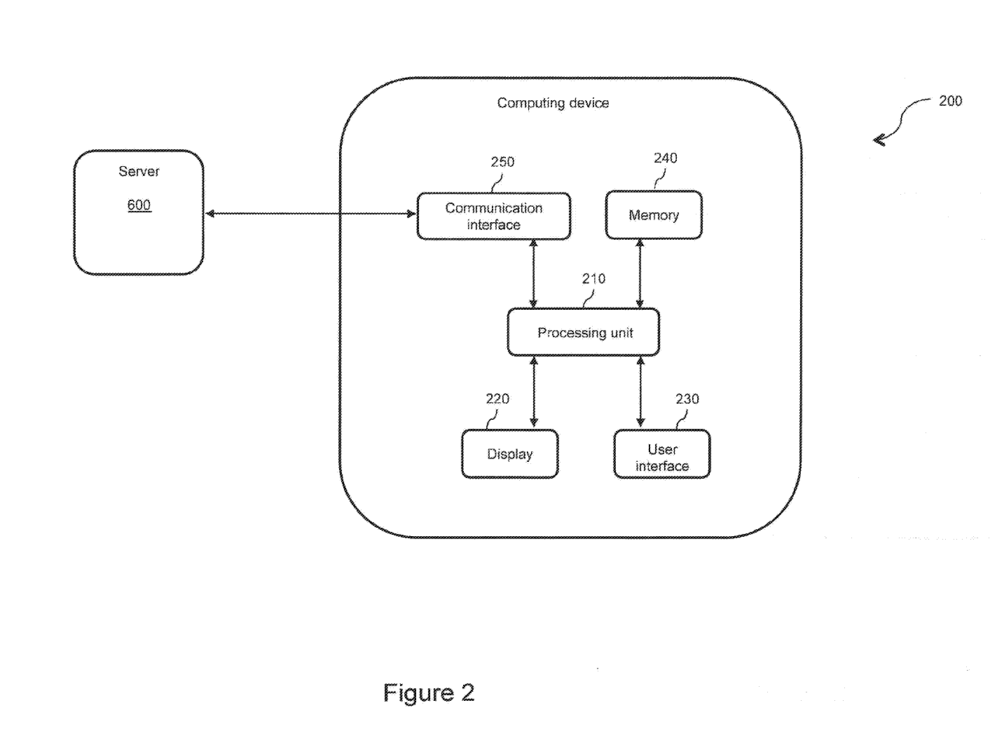

Referring now concurrently to FIGS. 2, 3A-3F and 4A-4B, a computing device 200 for collectively gathering reliable facts, a graphical user interface (GUI) 300 for collectively gathering reliable facts, and a method 400 for collectively gathering reliable facts are illustrated.

The computing device 200 is used by a member of the community of contributors, to participate in the collective gathering of reliable facts. The computing device 200 may consist of various types of devices, including a computer, a laptop, a smartphone, a tablet, a connected television, etc.

The computing device 200 comprises a processing unit 210, having one or more processors (not represented in FIG. 2) capable of executing instructions of a computer program. The computing device 200 comprises a memory 240 for storing instructions of the computer program, data generated by the execution of the computer program, etc. Only a single memory 240 is represented in FIG. 2, but the computing device 200 may comprise several memories, including volatile memory (such as a volatile Random Access Memory (RAM)) and non-volatile memory (such as a hard drive). The computing device 200 comprises a display 220 (e.g. a regular screen or a tactile screen) for displaying data generated by the computer program and a user interface 230 (e.g. a keyboard, a mouse, a tactile screen) for allowing a user to interact with the computer program. The computing device 200 further comprises a communication interface 250 for exchanging data with other entities (such as a server 600) via communication links (e.g. a cellular network, a fixed Internet network, etc.).

In the rest of the description, we refer to specific instructions of a specific computer program. The instructions are comprised in a computer program product and provide for collectively validating facts when executed by a processor of the processing unit 210. The computer program product is deliverable via an electronically-readable media such as a storage media or communication links (via the communication interface 250). The instructions of the computer program implement the steps of the method 400 which are executed on the computing device 200.

The server 600 is a centralized entity which exchanges data with a plurality of computing devices 200, and more specifically computes data collected by the plurality of computing devices 200 in order to implement the process of collectively gathering reliable facts. The server 600 will be detailed later in the description.

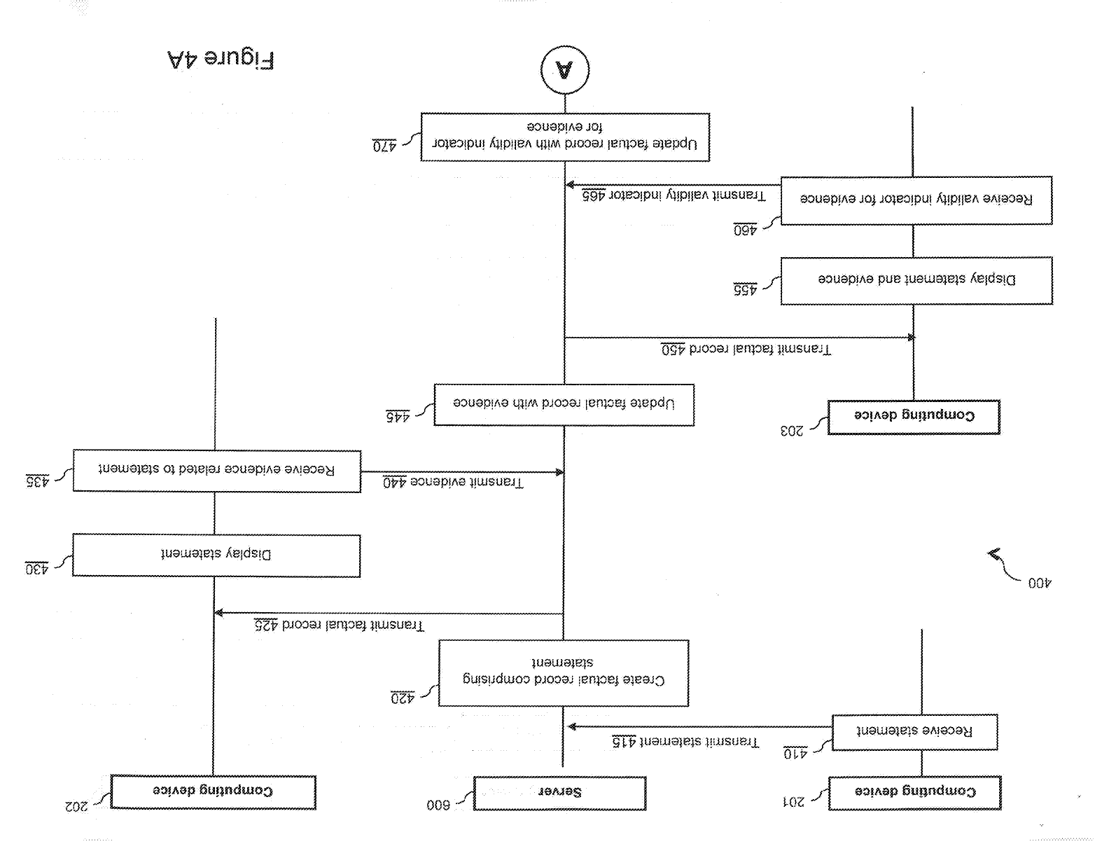

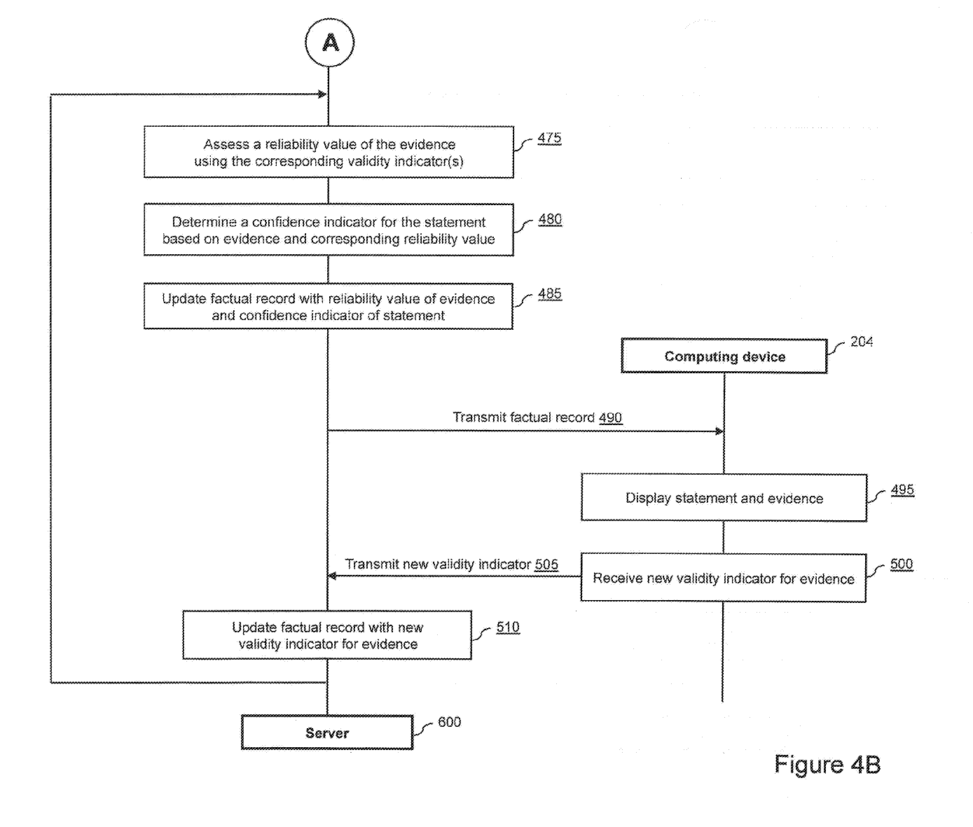

FIGS. 4A and 4B are an exemplary illustration of interactions of the server 600 with four different computing devices 201, 202, 203 and 204 corresponding to the computing device 200. Each of the four computing devices 201, 202, 203 and 204 execute instructions of the computer program product, to implement different stages of the collective validation of facts by computing devices 200. FIGS. 4A and 4B more specifically illustrate the processing of a specific statement, and are not meant to be limitative, since more or less computing devices 200 may be involved in the processing of this specific statement. In particular, the same processing device 200 may perform steps performed by two or more processing devices (e.g. 201 and 203) in FIGS. 4A and 4B.

Executing the instructions of the computer program product includes displaying the GUI 300 on the display 220 of a computing device 200. The GUI 300 facilitates interactions with the user of the computing device 220, by displaying data generated by the processing unit 210 when executing the instructions of the computer program or displaying data received via the communication interface 250. The GUI 300 also facilitates the provision of data by the user via the user interface 230, by displaying interactive graphical elements (such as menus, data collection widgets, etc.) for provisioning the data.

The computer program may consist of an application executed by the computing device 220 to implement the method 400 (e.g. an applet on a tablet or a smartphone), and the GUI 300 consists in a dedicated interface of the computer program. Alternatively, the computer program may consist of a standard web browser (using dedicated web pages, scripts, etc. to implement the method 400), and the GUI 300 consists of a standard web interface customized by the dedicated web pages, scripts, etc.

In a particular aspect, executing the instructions of the computer program product comprises receiving 410 via the user interface 230 of a first computing device 201 a new statement (not represented in the Figures). Executing the instructions further comprises transmitting 415 the new statement to the server 600 via the communication interface 250 of the first computing device 201. Although not represented in the Figures, the GUI 300 may comprise a dedicated page including a graphical element (such as a text entry, etc.) for allowing the user to enter the new statement via the user interface 230.

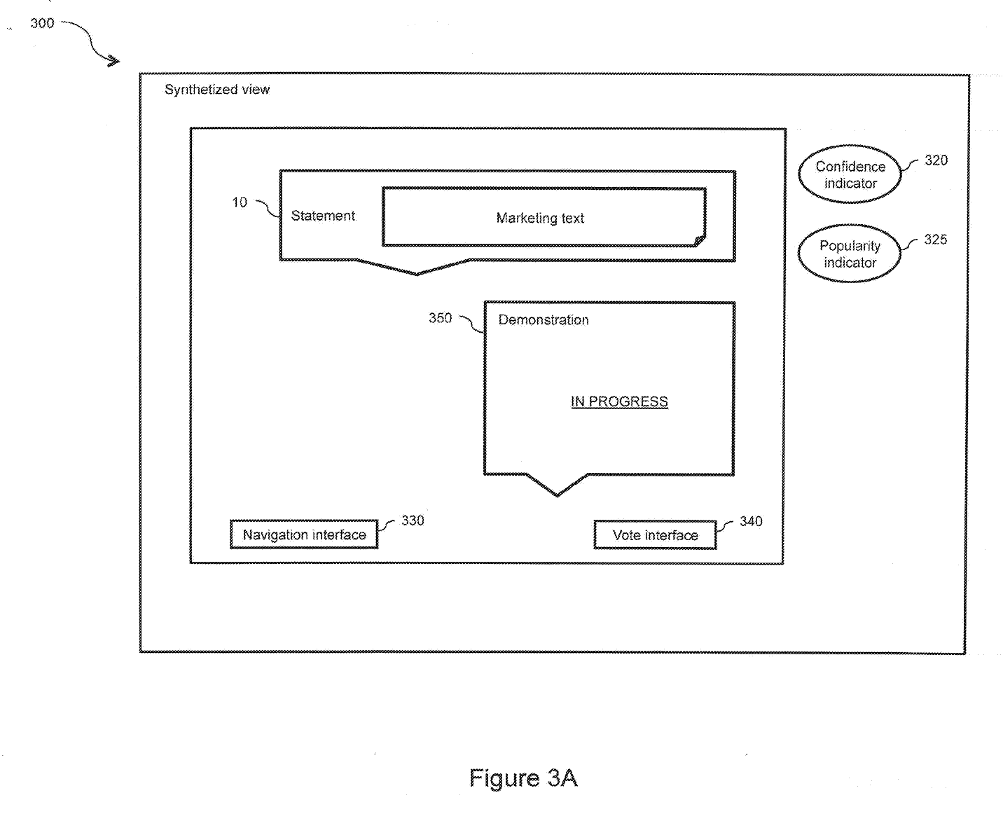

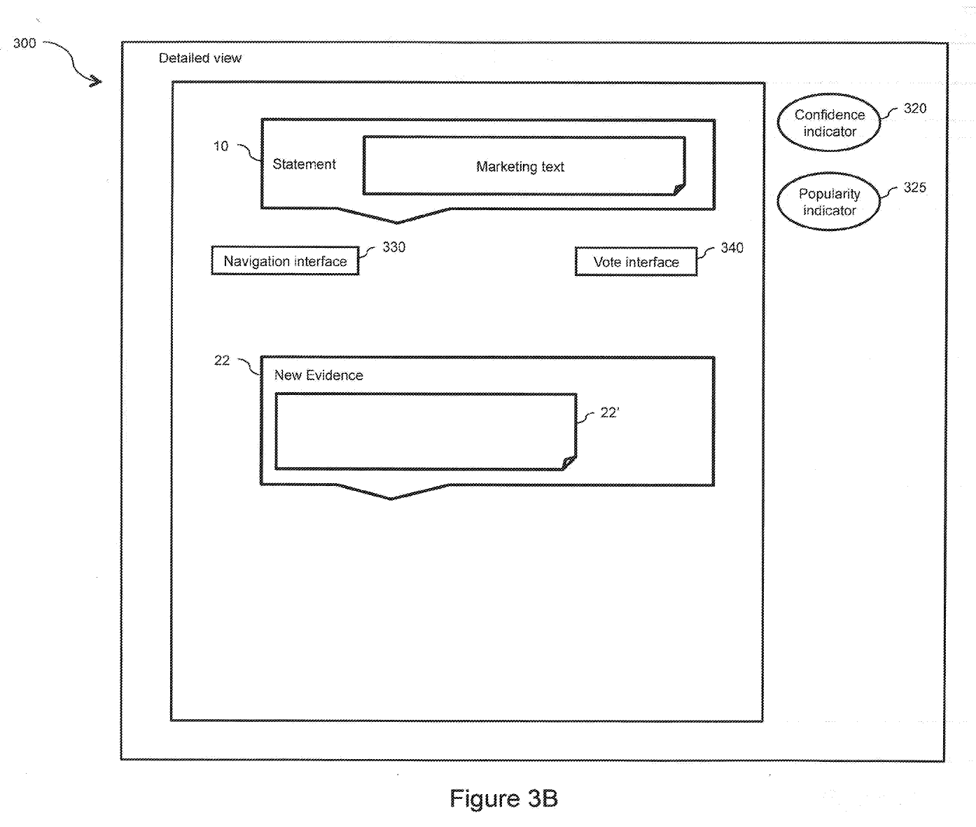

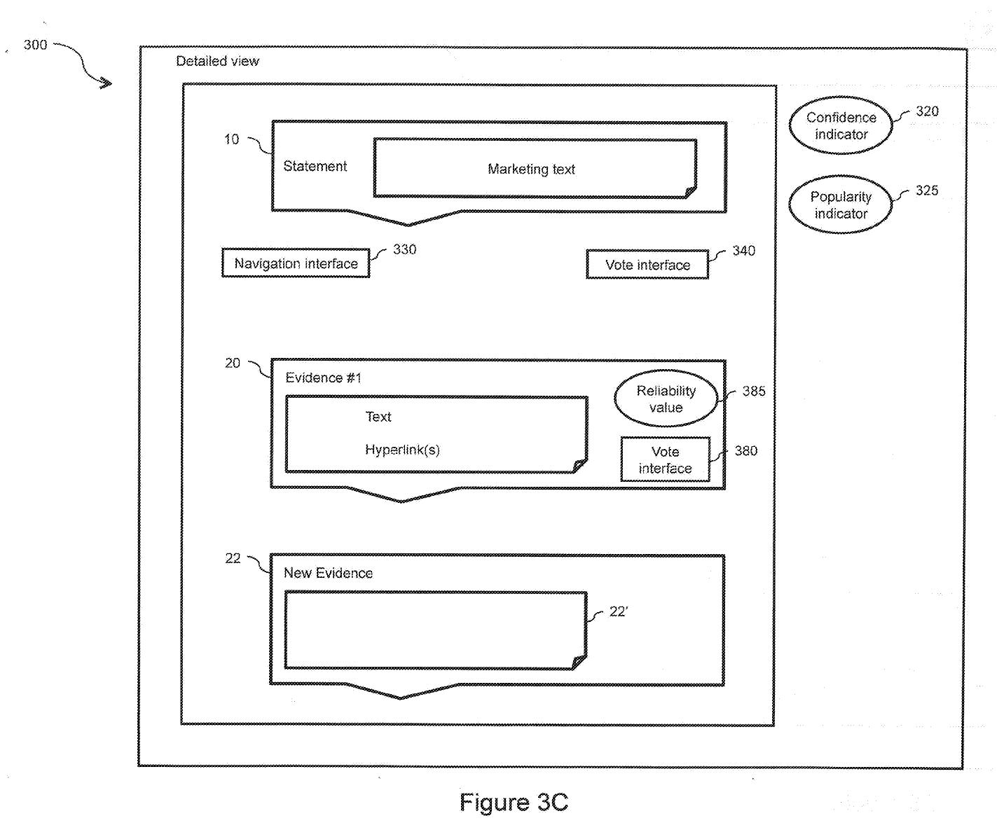

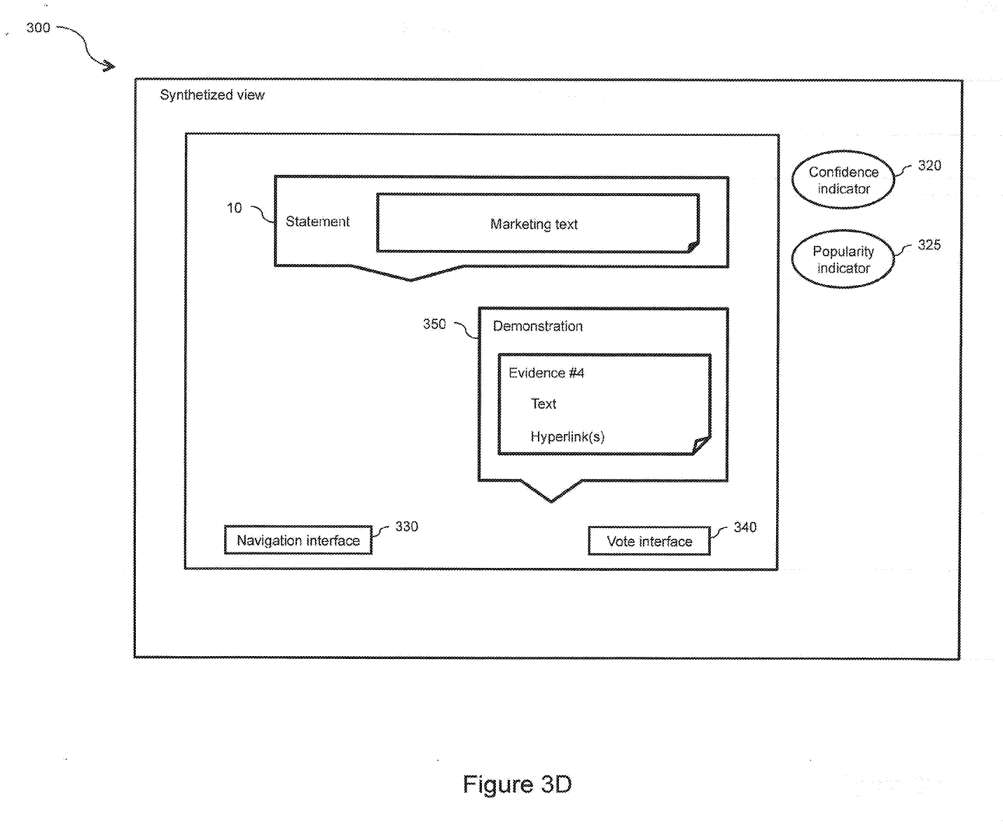

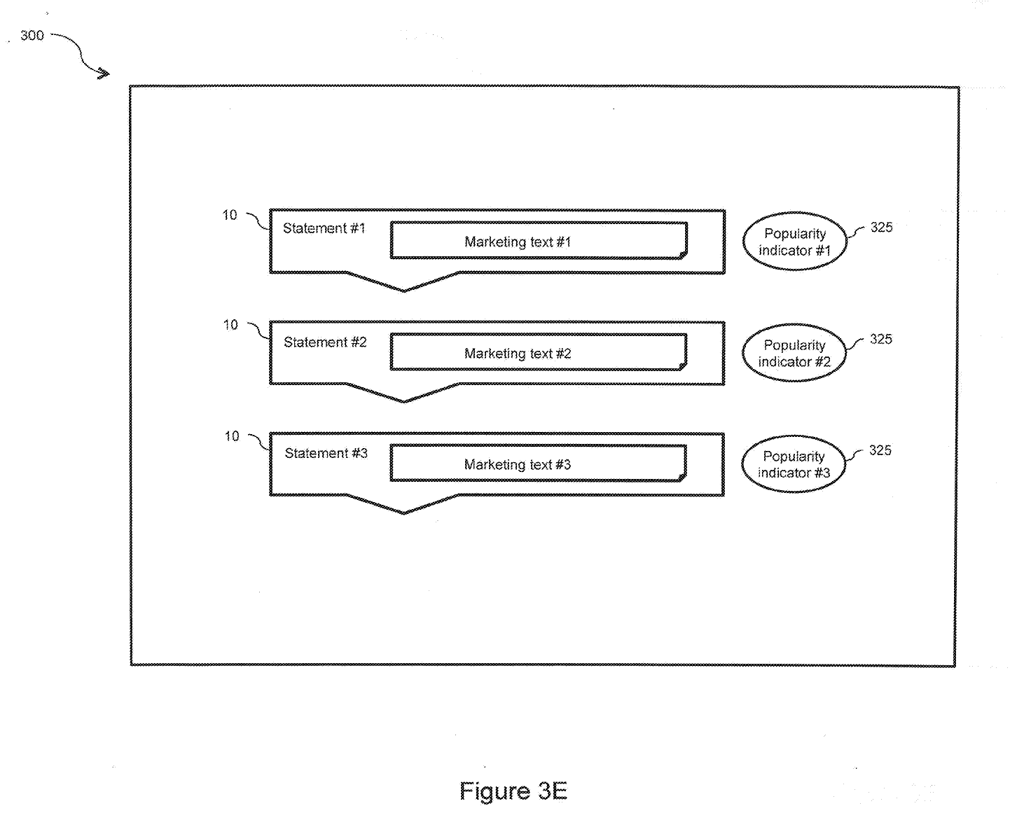

In another particular aspect, executing the instructions of the computer program product comprises receiving 425 from the server 600 via the communication interface 250 of a second computing device 202 a factual record. This factual record is a factual record at a preliminary stage, generated by the server 600 (as will be detailed later in the description), and comprising a statement 10 and no evidence yet. Executing the instructions further comprises displaying 430 the statement 10 on the display 220 of the computing device 200, and more specifically in the GUI 300, as illustrated in FIGS. 3A and 3B.

FIGS. 3A and 3D illustrate a first page of the GUI 300 for presenting a synthetized view of the data related to a factual record. The synthetized view displays the statement 10 of the factual record. The synthetized view may be the default view presented to a user of a computing device 200

FIGS. 3B and 3C illustrate a second page of the GUI 300 for presenting a detailed view of the data related to a factual record. The detailed view displays the statement 10 of the factual record, a graphical element for the user to enter a new evidence 22, and evidence(s) 20 related to the statement 10 if present in the factual record.

A navigation interface 330 (e.g. an icon, a button, etc.) allows the user to navigate between the synthetized view (FIGS. 3A and 3D) and the detailed view (FIGS. 3B and 3C).

Executing the instructions further comprises receiving 435 via the user interface 230 of the second computing device 202 a new evidence 22 related to the statement 10, and transmitting the new evidence 22 to the server 600. FIG. 3B illustrates the currently described case, where the factual record comprises a statement 10 and no evidence yet. A first new evidence 22 is entered by the user via the detailed view of the GUI 300, through a graphical element 22′ (such as a text entry, etc.).

In still another particular aspect, executing the instructions of the computer program product comprises receiving 450 from the server 600 via the communication interface 250 of a third computing device 203 a factual record. The factual record includes a statement 10 and an evidence 20 related to the statement 10.

Executing the instructions further comprises displaying 455 the statement 10 and the evidence 20 on the display 220 of the computing device 203. For instance, the statement 10 is displayed in the synthetized view of the GUI 300 illustrated in FIG. 3A. Additionally, the statement 10 and the evidence 20 are both displayed in the detailed view of the GUI 300 illustrated in FIG. 3C.

Executing the instructions further comprises receiving via the user interface 230 of the computing device 203 one of the following: a validity indicator for the evidence 20 or a new evidence 22 related to the statement 10; and transmitting to the server 600 one of the following: the validity indicator for the evidence 20 or the new evidence 22 related to the statement 10.

FIG. 4A illustrates the reception 460 of the validity indicator for the evidence 20 by the computing device 203, and the transmission 465 of the validity indicator to the server 600. FIG. 3C illustrates that the validity indicator may be received via a vote interface 380 associated to the evidence 20. The vote interface 380 may consist of a graphical element, such as a menu, button(s), icon(s), etc. The validity indicator may consist of a determination by the user that the evidence 20 is either relevant or irrelevant, via the vote interface 380.

FIG. 4A does not specifically illustrate the reception of the new evidence 22 related to the statement 10 by the computing device 203, and the transmission of the new evidence to the server 600. However, these steps are similar to the steps 435 and 440 performed by the computing device 202, and have been described already. FIG. 3C illustrates the display in the detailed view of the GUI 300 of the received evidence 20 and of a graphical element 22′ (such as a text entry, etc.) for entering the new evidence 22.

FIGS. 4A and 4B illustrate that a first validity indicator for the evidence 20 is received 460 at the computing device 203, and transmitted to the server 600. The factual record is later transmitted 490 to a fourth computing device 204, the statement 10 and the evidence 20 of the factual record are displayed 495 on the display 220 of the computing device 204, a new validity indicator for the evidence 20 is received 500 via the user interface 230 of the computing device 204, and the new validity indicator is transmitted 505 to the server 600. More generally, for a particular evidence 20 related to a particular statement 10 of a factual record, a plurality of validity indicators can be generated (via the vote interface 380 represented in FIG. 3C) by a plurality of computing devices 200 and transmitted to the server 600.

For simplification purposes, FIG. 3C illustrates the display in the detailed view of the GUI 300 of a single received evidence 20. However, the factual record received 450 by the computing device 203 may include a plurality of evidences 20 related to the statement 10. In this case, the plurality of evidences 20 is displayed on the display 220 of the computing device 203. A specific validity indicator can be received 460 via the user interface 230 of the computing device 203 for a specific one among the plurality of evidences 20, and the specific validity indicator is transmitted 465 to the server 600. The data transmitted to the server 600 may also include an identification of the specific evidence 20 to which the specific validity indicator is related. The detailed view of the GUI 300 may display the plurality of evidences 20 in a convenient manner, as is well known in the art. For example, the plurality of evidences 20 may be stacked vertically and a particular navigation interface (such as a scroller) may be used if all the evidences cannot be displayed on the detailed view of the GUI 300 at the same time. Each one of the plurality of evidences 20 may have its own vote interface 380, in order to allow the user of the computing device 203 to generate a specific validity indicator for each specific evidence 20 displayed in the GUI 300.

In yet another particular aspect, the statement 10 may consist of a marketing text related to one of a product or a service. For example, the statement 10 may assert that a product has a particular quality, is particularly useful in particular circumstances, etc. Similarly, the statement 10 may assert that a service is very popular among a particular category of users, is well adapted for addressing a particular need or problem, etc. The marketing text may have a pre-defined maximum number of characters.

In another particular aspect, the evidence 20 comprises a text and at least one hyperlink related to the text. The text may include fact(s) gathered by a user of a computing device 220 in order to prove the validity of the corresponding statement 10. The one or more hyperlinks support the gathered fact(s), by referencing web pages of web sites where additional information can be found in support of the fact(s). Each evidence 20 may include a pre-defined maximum number of hyperlinks, for instance three. Additionally, the text may have a pre-defined maximum number of characters.

In still another particular aspect, the factual records transmitted by the server 600 to the computing devices 200 may include at least one of the following: a confidence indicator of the statement 10 and a reliability value of the evidence 20. The confidence indicator of the statement 10 is determined by the server 600 and the reliability value of the evidence 20 is assessed by the server 600, as will be detailed later in the description. The at least one of the confidence indicator of the statement 10 and the reliability value of the evidence 20 is displayed on the display 220 of the computing device 200.

FIGS. 3A and 3D illustrate that a received confidence indicator 320 related to a received statement 10 can be displayed in the synthetized view of the GUI 300; while FIGS. 3B and 3C illustrate that the received confidence indicator 320 can be displayed in the synthetized view of the GUI 300. FIG. 3C illustrates that a received reliability value 385 related to a received evidence 20 can be displayed in the detailed view of the GUI 300. In the case where several received evidences 20 associated to the statement 10 are displayed in the detailed view of the GUI 300 (not illustrated in FIG. 3C for simplification purposes), each specific evidence 20 has its own specific reliability value 385 assessed and transmitted by the server 600, which is displayed with its corresponding specific evidence 20.

In yet another particular aspect, executing the instructions of the computer program product comprises receiving via the user interface 230 of a computing device 200 a validity indicator for the statement 10. Executing the instructions further comprises transmitting the validity indicator for the statement 10 to the server 600 via the communication interface 250 of the computing device 200. The validity indicator for the statement 10 can be used by the server 600 for determining the confidence indicator of the statement 10, as will be detailed later in the description. FIGS. 3A-D illustrate that the validity indicator for the statement 10 may be received via a vote interface 340 associated to the statement 10. The vote interface 340 may consist of a graphical element, such as a menu, button(s), icon(s), etc. The validity indicator of the statement 10 may consist of a determination by a user of the computing device 200 that the statement 10 is either relevant or irrelevant, via the vote interface 340. With this additional option, the user may directly vote on the statement 10, submit its own evidence 22 or vote on evidence(s) 20 submitted by other users (as illustrated in FIG. 3C).

In another particular aspect, the factual records transmitted by the server 600 to the computing devices 200 may include a demonstration of the statement 10. As will be detailed later in the description, the server 600 may determine at some point that the statement 10 is true, based for example on the corresponding confidence indicator. The server 600 then generates a demonstration for the statement 10. For example, the demonstration may consist of the evidence 20 related to the statement 10 with the highest reliability value. The demonstration 350 of the statement 10 transmitted by the server 600 may be displayed in the synthetized view of the GUI 300 (represented in FIGS. 3A and 3D). For illustration purposes, FIG. 3A represents a case where the demonstration 350 has not been determined yet by the server 600, and is consequently not transmitted to the computing device 200. Thus, the synthetized view of the GUI 300 may include an indicator (for example, the text IN PROGRESS as illustrated in FIG. 3A) that no demonstration 350 has been determined yet. FIG. 3D represents a case where the demonstration 350 has been determined by the server 600, and is transmitted to the computing device 200. Thus, the synthetized view of the GUI 300 may include the demonstration 350 of the statement 10 (for example, evidence #4 which has been determined to have the highest reliability value by the server 600, as illustrated in FIG. 3D).

In still another particular aspect, the factual records transmitted by the server 600 to the computing devices 200 may include a popularity indicator of the statement 10. The server 600 may determine the popularity indicator of the statement 10 based on one or more criteria, including the number of times the statement 10 is transmitted to a computing device 200, the confidence indicator of the statement 10, the number of evidences 20 related to the statement 10, the number of validity indicators related to the evidences 20 of the statement 10, etc. The popularity indicator 325 of the statement 10 transmitted by the server 600 may be displayed in the synthetized and/or detailed views of the GUI 300 (as illustrated in FIGS. 3A-D).

In yet another particular aspect, executing the instructions of the computer program product may comprise determining by a user of the computing device 200 one or several criteria related to statements 10. The GUI 300 may include a specific page (not represented in the Figures) with dedicated graphical element(s) (e.g. a menu, a text entry, etc.) for allowing the user to select the criteria via the user interface 230 of the device 200. The criteria may include categories to which the statements 10 belong, key-words included in the text of the statements, date of creation of the statements 10, etc. The criteria are transmitted to the server 600, which returns a set of factual records for which the statements 10 match the criteria. The GUI 300 may include a specific page illustrated in FIG. 3E for displaying the received statements 10 corresponding to the criteria. The user may select (via the user interface 230) one among the plurality of displayed statements 10, based on his interest for the text of the selected statement 10. Additionally, the popularity indicator 325 of each statement 10 may be displayed, to help the user in its choice. Although not illustrated in FIG. 3E, the confidence indicator 320 of each statement 10 may also be displayed, to help the user in its choice. Upon selection of a specific statement 10 by the user, the synthetized view (illustrated in FIGS. 3A and 3D) corresponding to the selected statement 10 may be displayed in the GUI 300. From there, the user may navigate between synthetized view (FIGS. 3A and 3D) and the detailed view (FIGS. 3B and 3C) via the navigation interface 330.

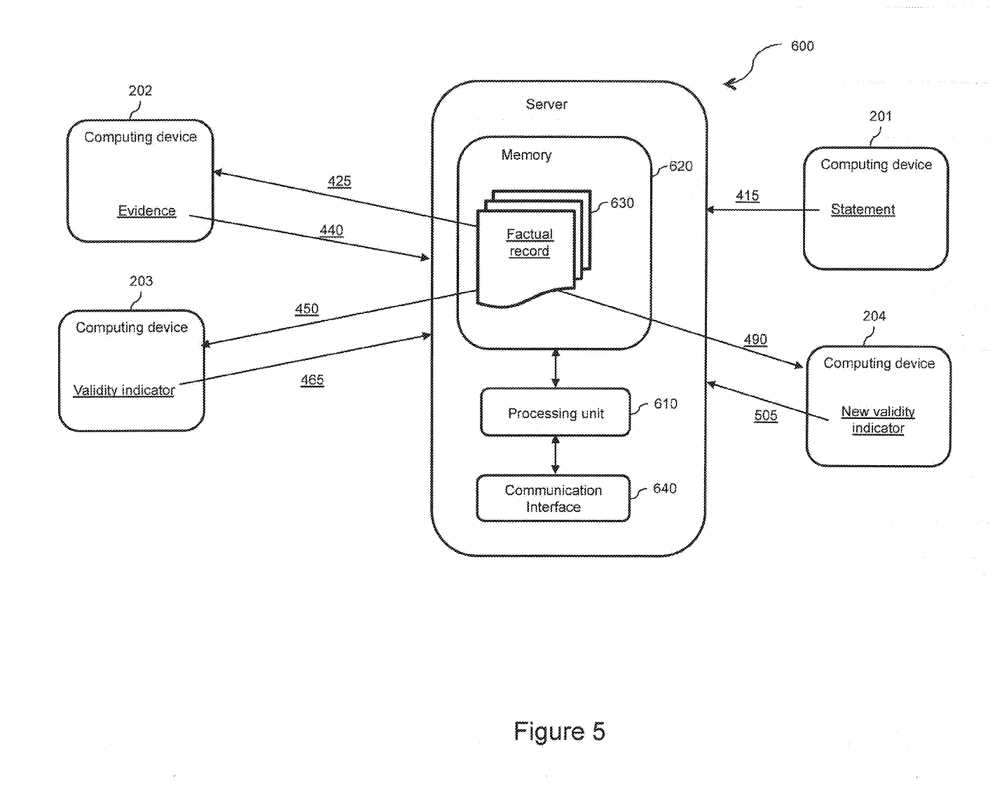

Reference is now made concurrently to FIGS. 4A-4B, and to FIG. 5 which represents the server 600 for collectively gathering reliable facts.

The server 600 comprises a processing unit 610, having one or more processors (not represented in FIG. 5) capable of executing instructions of a computer program. The server 600 comprises a memory 620 for storing instructions of the computer program, data generated by the execution of the computer program such as factual records 630, etc. Only a single memory 620 is represented in FIG. 5, but the server 600 may comprise several memories, including volatile memory (such as a volatile Random Access Memory (RAM)) and non-volatile memory (such as a hard drive). The server 600 further comprises a communication interface 640 for exchanging data with other entities (such as the computing devices 201, 202, 203 and 204) via communication links (e.g. a cellular network, a fixed Internet network, etc.).

The server 600 receives 415 via its communication interface 640 a statement sent by a computing device (e.g. 201). The processing unit 610 of the server 600 creates 420 a factual record 630 comprising the received statement and stores the factual record 630 in its memory 620.

The server 600 may transmit 425 via its communication interface 640 the factual record 630 comprising the statement to one or more computing devices (e.g. 202). The server 600 receives 440 via its communication interface 640 an evidence related to the statement sent by a computing device (e.g. 202). The processing unit 610 of the server 600 updates 445 the factual record 630 with the evidence related to the statement.

The server 600 may transmit (e.g. 450 and 490) via its communication interface 640 the factual record 630 comprising the statement and the evidence to one or more computing devices (e.g. 203 and 204). The server 600 receives via its communication interface 640 at least one validity indicator for the evidence. For example, the server 600 receives 465 via its communication interface 640 a first validity indicator related to the evidence, sent by a computing device (e.g. 203). The server 600 also receives 505 via its communication interface 640 a second validity indicator related to the evidence, sent by another computing device (e.g. 204). The processing unit 610 of the server 600 updates (e.g. 470 and 510) the factual record 630 with the at least one received validity indicator (e.g. first validity indicator received 465 from computing device 203 and second validity indicator received 505 from computing device 204). The server 600 may receive a plurality of validity indicators from a plurality of computing devices (e.g. 201, 202, 203 and 204), and updates the factual record 630 with the plurality of received validity indicators.

The processing unit 610 of the server 600 assesses 475 a reliability value of the evidence using the at least one corresponding validity indicator. The processing unit 610 of the server 600 determines 480 a confidence indicator for the statement based on the evidence and the corresponding reliability value. The processing unit 610 of the server 600 updates 485 the factual record 630 with the assessed reliability value of the evidence and the determined confidence indicator of the statement. As illustrated in FIG. 4B, the steps of assertion 475, determination 480 and update 485 represent an iterative process, which is repeated each time a new validity indicator for the evidence is received by the server 600.

As previously mentioned, the statement may consist of a marketing text related to one of a product or a service. Furthermore, the evidence may comprise a text and at least one hyperlink related to the text.

As previously mentioned, several types of validity indicators may be available. A first type of validity indicator consists in the votes (e.g. the evidence is relevant or irrelevant) of the users of the computing devices (e.g. 203 and 204), and has already been described in details. A second type of validity indicator may consist of a vote (e.g. the evidence is relevant or irrelevant) provided by a pre-defined person, or a predefined group of persons, such as moderator(s) or skilled person(s) in the field related to the statement. A moderator or a skilled person may use the GUI 300 represented in FIGS. 3A to 3D in a manner similar to a regular contributing user. However, a moderator or a skilled person shall be identified as such, in order to be granted access to sections (not represented in the Figures) of the GUI 300 reserved for privileged users. At least, a vote from a moderator or a skilled user shall be identified in a particular manner when it is transmitted to the server 600, to differentiate it from a vote transmitted by a regular contributing user. A third type of validity indicator may consist of a source of the evidence. For example, when the evidence comprises hyperlinks, hyperlinks corresponding to a pre-defined set of web sites may be attributed a specific validity coefficient, which depends on each particular web site. Since all existing web sites cannot be taken into consideration, a hyperlink corresponding to a web site which is not in the pre-defined set of web sites may be allocated a default (low) validity coefficient.

The assessment of the reliability value of the evidence may be performed via a dedicated algorithm executed by a processor of the processing unit 610. For example, each particular type of validity indicator may be allocated a particular weighting factor, and the reliability value may be the sum of all received validity indicators weighted by their respective particular weighting factors. Furthermore, the reliability value may be normalized to represent a percentage. Other examples of dedicated algorithms may also be used, as a person skilled in the art would recognize.

In a particular aspect, the communication interface 640 of the server 600 receives a plurality of evidences related to the statement. The plurality of evidences is received from a plurality of computing devices (e.g. 202, 203 and 204). The computing device 201 which transmitted the statement may also transmit an evidence related to the statement. Furthermore, the same computing device (e.g. 202) may transmit several different evidences related to the statement. The processing unit 610 of the server 600 assesses a specific reliability value for each specific evidence among the plurality of received evidences and determines the confidence indicator for the statement based on the plurality of evidences and the corresponding plurality of reliability values.

The determination of the confidence indicator for the statement may be performed via a dedicated algorithm executed by a processor of the processing unit 610. For example, the confidence indicator may be determined by selecting a pre-defined number (e.g. 3) of evidences having the highest reliability value, and calculating the average reliability value of the selected evidences. In a variant of the previous algorithm, a requirement on the selected sources may be that they have a pre-defined number (e.g. 2) of sources (e.g. hyperlinks) with a high validity coefficient (as described previously). Furthermore, the confidence indicator may be normalized to represent a percentage. Other examples of dedicated algorithms may also be used, as a person skilled in the art would recognize.

In another particular aspect, the processing unit 610 of the server 600 determines if a received evidence is compliant with an ethic code, and further processes the received evidence only if it is compliant with the ethic code. Otherwise, the evidence is dropped. The determination of the compliance with the ethic code may be partially or entirely performed in an automatic way, using dedicated algorithms capable or parsing and analyzing the content of the evidence (e.g. the text and the hyperlinks). The determination may also be partially or entirely performed by a moderator or skilled person, capable of analyzing the evidence to determine its compliance with the ethic code.

As previously mentioned, the processing unit 610 of the server 600 may generate a demonstration for the statement. The demonstration may be generated when the processing unit 610 determines that the statement is true. The determination that the statement is true may be based on the value of the corresponding confidence indicator. For example, if the confidence indicator is higher that a pre-defined threshold, the statement is determined to be true. The determination that the statement is true may take into consideration other criteria, such as for example a minimum number of evidences received for the statement, a minimum number of evidences for the statement having a reliability value higher than a pre-defined threshold, etc. The demonstration may be generated automatically by the processing unit 610, for example by selecting as demonstration the evidence with the highest reliability value. Alternatively, the demonstration may be generated manually by a moderator or a skilled person, using the evidences with the highest reliability values as sources for writing a convincing demonstration. Furthermore, the demonstration of the statement may be transmitted to the computing devices (e.g. 201, 202, 203), as illustrated previously in relation to FIGS. 3A and 3D.

As previously mentioned, the processing unit 610 of the server 600 may determine a popularity indicator of the statement (based on one or a plurality of predefined criteria). The factual record 630 may be updated with the determined popularity indicator. Furthermore, the popularity indicator of the statement may be transmitted to the computing devices (e.g. 201, 202, 203), as illustrated previously in relation to FIGS. 3A-E.

In still another particular aspect, the communication interface 640 of the server 600 receives a plurality of statements. The processing unit 610 of the server 600 creates a specific factual record 630 for each specific statement among the plurality of received statements, and stores the plurality of factual records 630 in the memory 620. The processing unit 610 is capable of applying the aforementioned treatments and algorithms to each specific statement, independently of the other statements. Each specific factual record 630 has a specific statement with its own confidence indicator, and one or more evidences related to the specific statement with corresponding reliability values, as illustrated in FIG. 1.

In yet another particular aspect, the processing unit 610 of the server 600 determines a specific fee to be charged for each specific statement, based on a number of interactions related to the specific statement performed by the processing unit 610. The interactions may include one or several of the following: transmission of a statement to a computing device, reception of an evidence of a validity indicator from a computing device, calculation of a reliability value or a confidence indicator, etc.

As previously mentioned, the communication interface 640 of the server 600 may receive at least one validity indicator for a statement. For example, as illustrated in FIGS. 3A-D, a user of a computing device (e.g. 203 or 204) may vote on the statement, and generate a corresponding validity indicator for the statement, which is transmitted to the server 600. The processing unit 610 of the server 600 may update the factual record 630 corresponding to the statement with the at least one received validity indicator for the statement. The processing unit 610 may further assess a reliability value of the statement using the at least one corresponding validity indicator. The assessment of the reliability value of the statement may be similar to an assessment of a reliability value of an evidence. The processing unit 610 may determine the confidence indicator for the statement based on a combination of: the evidence(s) and the corresponding reliability value(s) of the evidence(s), and the reliability value of the statement.

In another particular aspect, the statement may consist of an answer to a question. The question may be related to any subject of interest, and may consist of a text stating the question, a context (a text) providing additional information with respect to the question, and at least one hyperlink related to the context (to provide sources in the form of web pages for supporting the additional information included in the context).

The question may be entered via a user interface of a first computing device (not represented in the Figures) and transmitted to the server 600. The question may be transmitted by the server 600 to a second computing device (e.g. 201) and displayed on a display of the second computing device. A statement answering the question may be entered via a user interface of the second computing device and transmitted to the server 600. From this point, the statement answering the question is treated as previously described by the server 600 and the computing devices (e.g. 201, 202, 203 and 204) interacting with the server 600. Several statements answering the question may be generated by various computing devices, and transmitted to the server 600. A specific factual record 630 is created for each specific statement received by the server 600 and answering the question, as previously described.

In still another particular aspect, the server 600 memorizes the history of each factual record, including information which were accurate at a certain time in the existence of the factual record, but which are currently no longer accurate. For instance, the history may include previous versions of the demonstration of the statement of a factual record, the demonstration having evolved in time based on the submission of new evidences. The history may also include evidences that have been rejected because they were not compliant with a rule of the ethic code. However, specific rules of the ethic code (e.g. no racist, pornographic, defamatory, etc., content is allowed) may trigger the final rejection of an evidence, without memorizing it in the history of the related factual record. The GUI 300 illustrated in FIGS. 3A-D may include a graphical element (e.g. a button, an icon, etc.) for triggering the display of the history of the factual record.

In yet another particular aspect, the GUI 300 illustrated in FIG. 3B may include a graphical element (e.g. a button, an icon, etc.) for automatically memorizing the content of a hyperlink submitted with a new evidence 22. Thus, if the owner of the web site related to the hyperlink removes the content of the hyperlink, the memorized copy is still available to support the new evidence 22. For instance, a screenshot of the content of the hyperlink may be taken and memorized with the new evidence 22. Furthermore, once the new evidence 22 has been submitted to the server 600, validated by the server 600 (compliance with the ethic code) and added by the server 600 to the corresponding factual record, the screenshot may be displayed with the hyperlink of the validated evidence 20 in the GUI 300 illustrated in FIG. 3C.

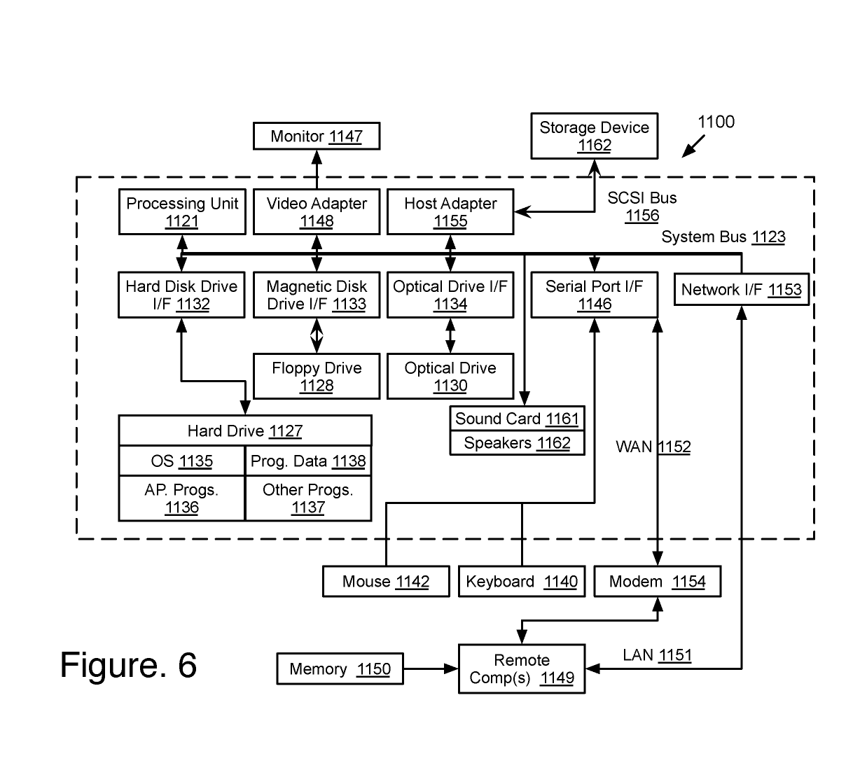

FIG. 6 and the following discussion provide a brief, general description of an exemplary apparatus in which at least some aspects of the present invention may be implemented. The present invention will be described in the general context of computer-executable instructions, such as program modules, being executed by a personal computer. However, the methods of the present invention may be effected by other apparatus. Program modules may include routines, programs, objects, components, data structures, applets, WEB 2.0 type of evolved networked centered applications, etc. that perform a task(s) or implement particular abstract data types. Moreover, those skilled in the art will appreciate that at least some aspects of the present invention may be practiced with other configurations, including hand-held devices, multiprocessor systems, microprocessor-based or programmable consumer electronics, network computers, minicomputers, set top boxes, mainframe computers, gaming console and the like. At least some aspects of the present invention may also be practiced in distributed computing environments where tasks are performed by remote processing devices linked through a communications network. In a distributed computing environment, program modules may be located in local and/or remote memory storage devices.

With reference to FIG. 6, an exemplary apparatus 1100 for implementing at least some aspects of the present invention. The apparatus 1100 may include a processing unit 1121 and a system bus 1123 that couples various system components, including the system memory 1122, to the processing unit 1121. The system bus 1123 may be any of several types of bus structures including a memory bus or memory controller, a peripheral bus, and a local bus using any of a variety of bus architectures. The apparatus 1100 may also include a hard disk drive 1127 for reading from and writing to a hard disk, (not shown), a magnetic disk drive 1128 and an optical disk drive 1130. The hard disk drive 1127, magnetic disk drive 1128, and (magneto) optical disk drive 1130 may be coupled with the system bus 1123 by a hard disk drive interface 1132, a magnetic disk drive interface 1133, and a (magneto) optical drive interface 1134, respectively.

A user may enter commands and information into the apparatus 1100 through input devices, such as a keyboard 1140, a camera 1141 and pointing device 1142 for example. Other input devices (not shown) such as a microphone, joystick, game pad, satellite dish, scanner, a touch sensitive screen, accelerometers adapted to sense movements of the user or movements of a device, or the like may also be included. These and other input devices are often connected to the processing unit 1121 through a serial port interface 1146 coupled to the system bus. However, input devices may be connected by other interfaces, such as a parallel port, a game port, blue tooth connection or a universal serial bus (USB). For example, since the bandwidth of the camera 1141 may be too great for the serial port, the video camera 1141 may be coupled with the system bus 1123 via a video capture card (not shown). The video monitor 1147 or other type of display device may also be connected to the system bus 1123 via an interface, such as a video adapter 1148 for example. The video adapter 1148 may include a graphics accelerator. One or more speaker 1162 may be connected to the system bus 1123 via a sound card 1161 (e.g., a wave table synthesizer such as product number AWE64 Gold Card from Creative® Labs of Milpitas, Calif.). In addition to the monitor 1147 and speaker(s) 1162.

The apparatus 1100 may operate in a networked environment which defines logical connections to one or more remote computers.

When used in a LAN, the apparatus 1100 may be connected to the LAN 14 through a network interface adapter (or “NIC”) 1153. When used in a WAN, such as the Internet, the apparatus 1100 may include a modem 1154 or other means for establishing communications over the wide area network 1152 (e.g. Wi-Fi, WinMax). The modem 1154, which may be internal or external, may be connected to the system bus 1123 via the serial port interface 1146.

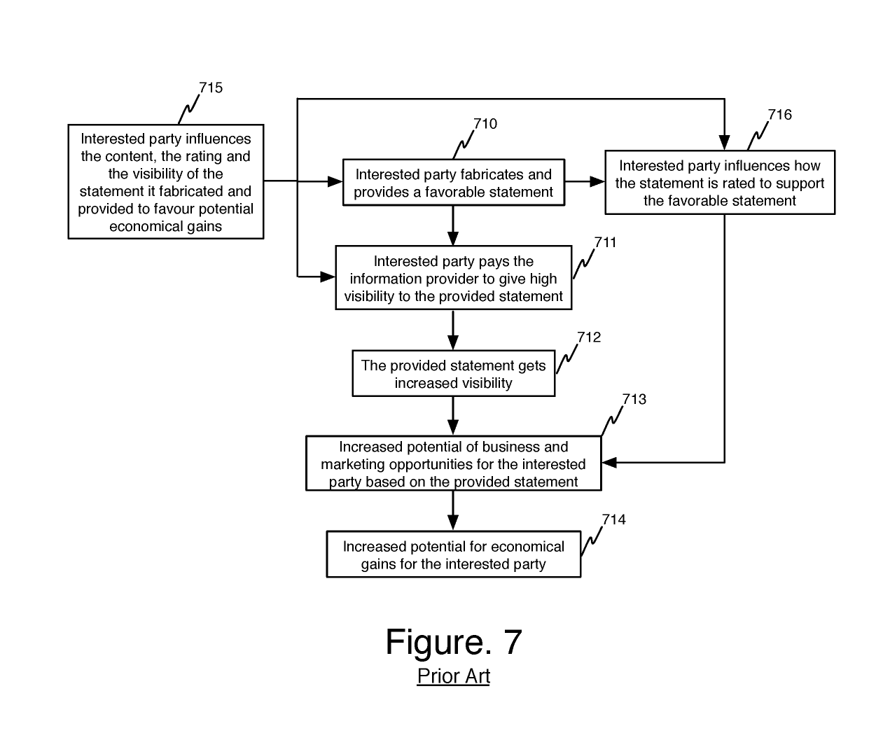

FIG. 7 is an illustration of a prior art method allowing an interested party to fabricate a favorable statement expected to serve its economical interests 710. The interested party fabricates a favorable statement with the expectation of improving its reputation and increasing its potential for business and marketing with the expectation of an economical gain. The interested party pays an information provider to increase the visibility of the favorable statement via a network 711 in order to have the favorable statement seen by a maximum of viewers. After the information provider receives the payment from the interested party it will act to increase the visibility of the favorable information 712 which gets more visibility and is expected to be seen by more viewers. The potential for business and marketing opportunities related to the favorable statement is increased by the fact that it is viewed by more viewers 713. The potential for economical gains for the interested party is increased 714 as the favorable statement may result in an increased reputation or more favorable business deals. To increase its likelihood of potential gains, the interested party also has an interest in influencing the rating of the favorable statement 716 through various means destined to give credence to the favorable statement and reinforcing its content. In the prior art, the interested party has the ability to fabricate the favorable statement, pay to increase the statement's visibility and influence the statement's rating to maximize the potential for business and marketing resulting from that favorable statement 715;

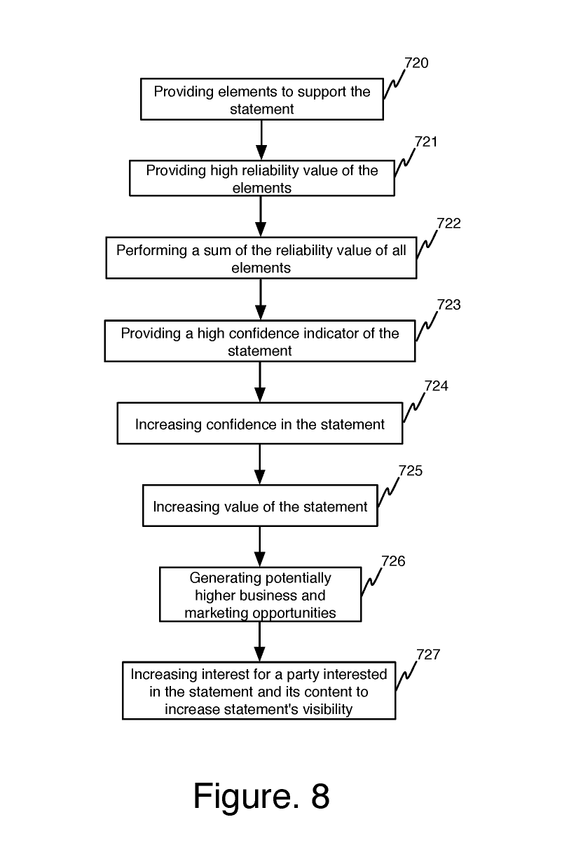

FIG. 8 is an illustration of the economical interest for an interested party to a have favorable statement to which a high level of confidence is associated. The statement is supported by various elements 720. The high reliability value of these elements 721, and the sum of these reliability values 722 will give a high confidence indicator 723 relating to the statement. The statement that has a high confidence indicator generates an increased confidence in this statement 724 as viewer are expected to more readily trust the statement and act on it. The Increased confidence in the statement translates into an increased value 725 of said statement as there is higher potential for business and marketing opportunities 726 which will increase the interest for an interested party to seek a higher visibility for the statement 727;

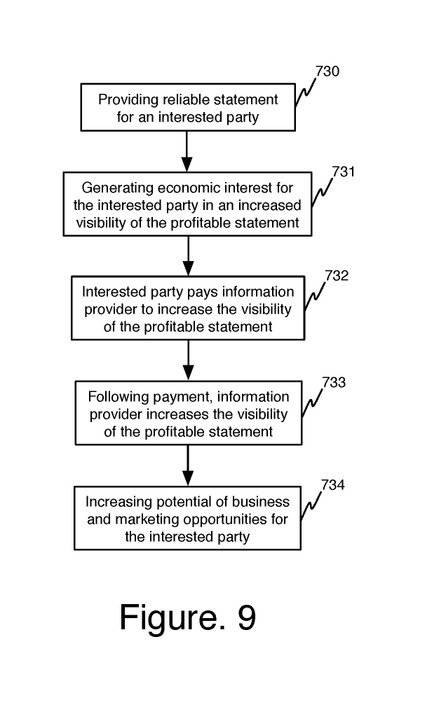

FIG. 9 is an illustration of the economical interest for an interested party to a get a favorable statement that is visible as it will increase the potential for business and marketing for the interested party. A profitable statement 730 for an interested party generates an economic interest 731 in favor of the interested party. The interested party pays the information provider so the profitable statement gets more visibility 732. Following the payment, the information provider increases the visibility of the profitable statement 733 which increases the potential for business and marketing for the interested party 734;

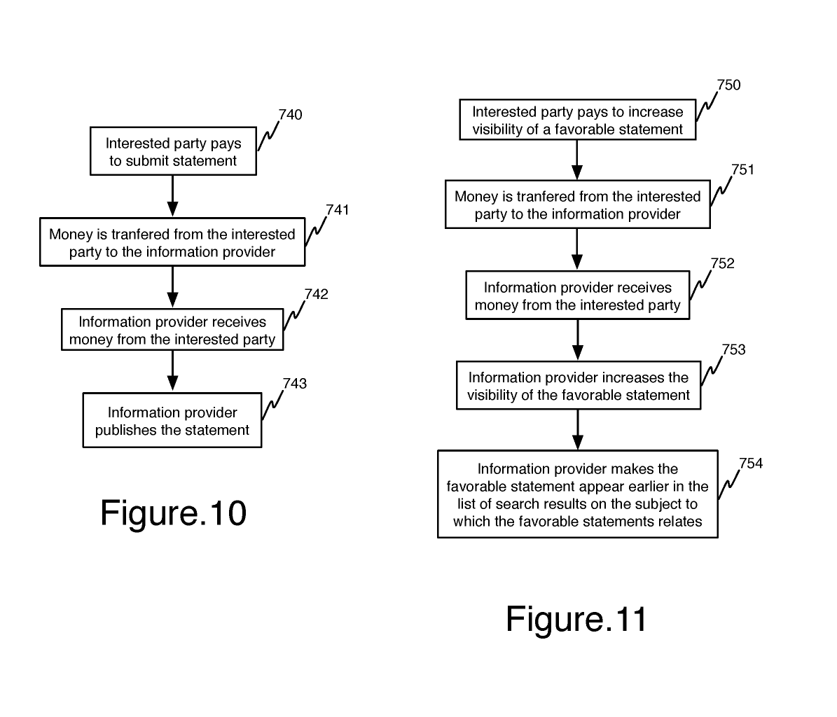

FIG. 10 is an illustration of the payment process between the interested party and the information provider to publish a statement. The interested party submits the statement 740, the interested party transfers money to the information provider 741. The information provider receives the money from the interested party 742 and publishes the statement 743;

FIG. 11 is an illustration of the payment process between the interested party and the information provider to increase the visibility of a statement. The interested party pays to increase the visibility of a favorable statement 750. Money is transferred from the interested party to the information provider 751. The information provider receives the money from the interested party 752 and increases the visibility of the favorable statement 753 by making the statement appear earlier in search results relating to the subject of the statement 754;

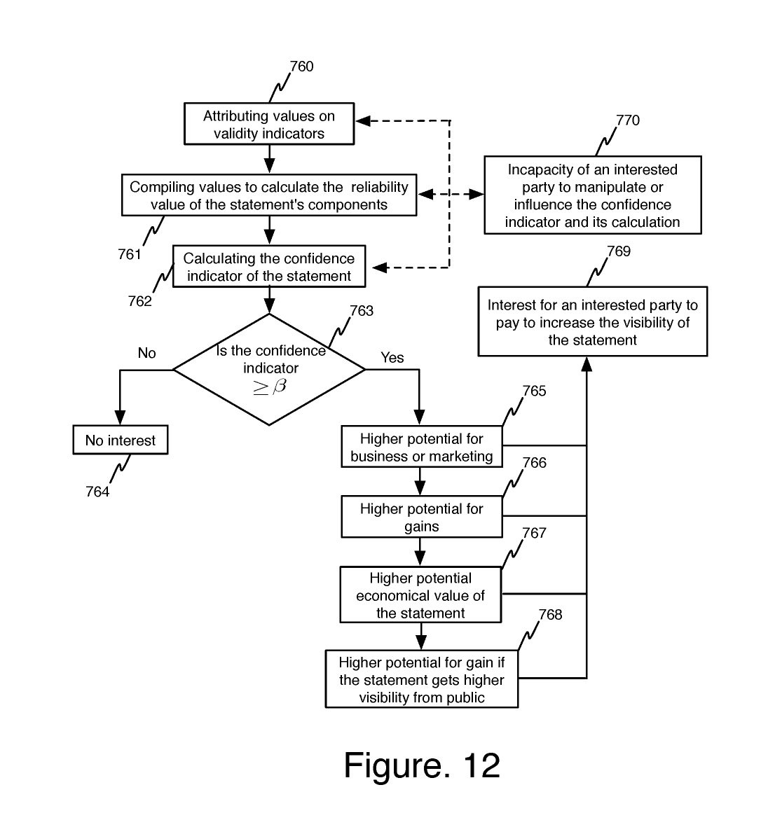

FIG. 12 is an illustration of the economical interest generated by the claimed method. Values are attributed to validity indicators 760, these values are compiled to calculate the reliability value of the components of the statement 761. Based on the reliability value, the confidence indicator of the statement is calculated 762. At this stage a test 763 can be applied do determine if the confidence indicator as a value superior or equal to a value β. The value β corresponds to a confidence indicator high enough for the viewer to readily have confidence in the statement. A low confidence indicator 764 in respect to β results in the statement to have no/low interest as it reflects a low confidence in the statement. A high confidence indicator 765 in respect to β means a higher potential for business or marketing, a higher potential for gains 766, a higher potential economical value of the statement 767 and a higher potential for gain if the statement has a higher visibility 768. The interested party has an advantage to pay to increase the statement with a high confidence indicator if it favors its interests 769. The interested party cannot manipulate or influence the confidence indicator of the statement and its calculation to serve its economical interests 770;

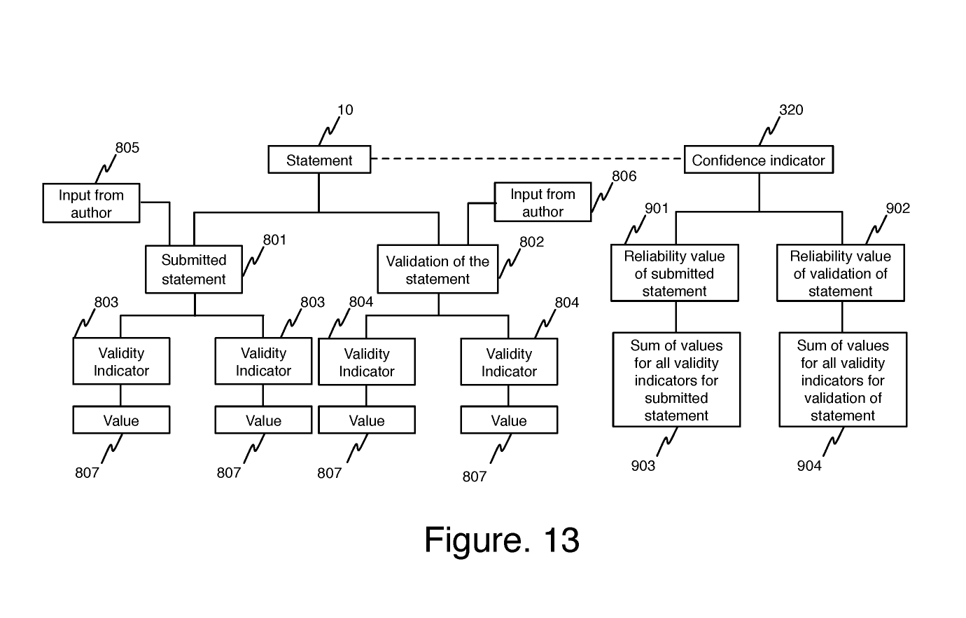

FIG. 13 is an illustration of the mechanism of the claimed method. A statement 10 and its associated confidence indicator 320 are displayed. The content of the statement is made on a basis of a statement 801 submitted by an author 805 and the validation of the statement 802 provided by the author 806. The submitted statement 801 has an associated reliability value 901 and the validation of the statement has an associated reliability value 902. A plurality of validity indicators 803 is associated with the submitted statement 801. A plurality of validity indicators 804 is associated with the validation of the statement. Each validity indicator 803 and 804 has an associated value 807. The sum 903 of the values 807 associated with the validity indicators 803 provides the reliability value 901 associated with the submitted statement 801. The sum 904 of the values 807 associated with the validity indicators 804 provides the reliability value 902 associated with the validation of the statement 802. The sum of the reliability value 901 associated with the submitted statement 801 and the reliability value 902 of the validation of the statement 802 provides the confidence indicator 320 associated with the statement 10.

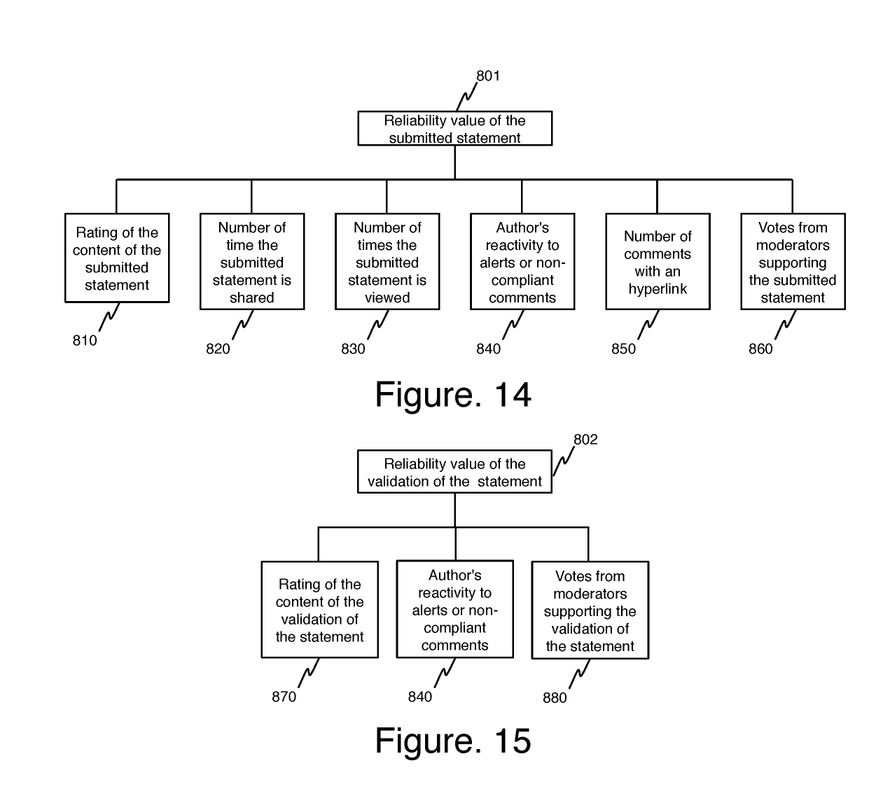

FIG. 14, illustrates the detail of the validity indicators used to calculate the reliability value 801 of the submitted statement. The calculation combines several validity indicators: the rating of the content of the submitted statement 810, the number of times the submitted statement is shared 820, the number of times the submitted statement is viewed 830, the author's reactivity to alerts and non-receivable comments 840, the number of comments with a hyperlink 850 and the votes from moderators supporting the submitted statement 860.

FIG. 15 illustrates the detail of the validity indicators used to calculate the reliability value 802 of the validation of the statement. The calculation combines several validity indicators: Rating of the content of the validation of the statement 870, author's reactivity to alerts, non-compliant comments 840, and votes from moderators supporting the validation of the statement 880.

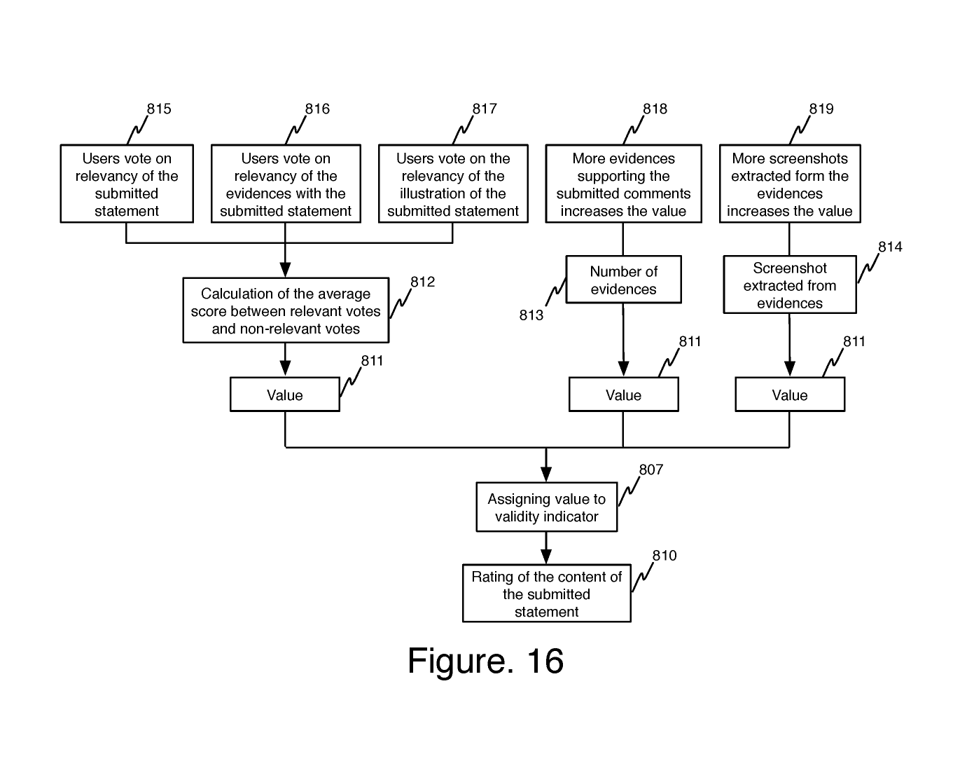

FIG. 16 illustrates the calculation of the value associated with the validity indicator based on the rating of the content of the submitted statement 810. The value 807 is assigned to the validity indicator 810. The value 807 is the sum of the plurality of values 811 obtained on the calculation of the average score between relevant votes and non-relevant votes 812, the number of evidences 813 and the screenshot(s) associated with the evidence 814. The users can vote to establish if the submitted statement is relevant or non-relevant 815, to establish if the context in which the statement is made is relevant or non-relevant 816, to establish if the illustration of the submitted comment is relevant or non-relevant 817. The average score between the relevant votes and the non-relevant votes is calculated 812 to provide the associated value 811. The number of evidences 813 in support of the submitted statement provides the associated value 811. More evidence in support of the submitted statement increases the resulting value 818. The screenshots associated with the evidences 814 and displaying their content provides the associated value 811. More screenshots increase the resulting value 819.

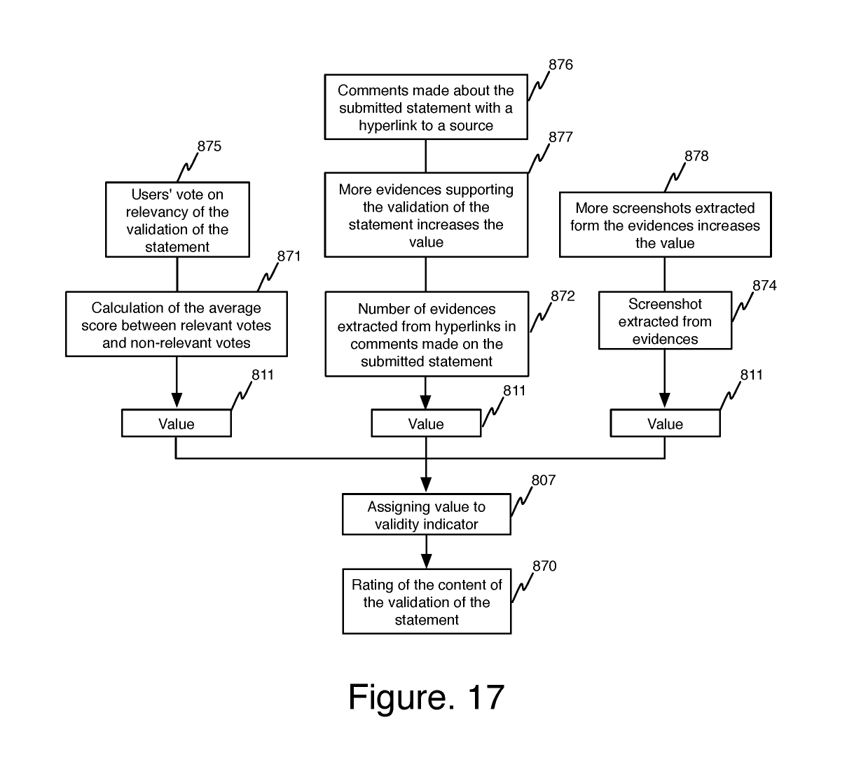

FIG. 17 illustrates the calculation of the value associated with the validity indicator based on the rating of the content of the validation of the statement 870. The value 807 is assigned to the validity indicator 870. The value 807 is the sum of the plurality of values 811 obtained on the calculation of the average score between relevant votes and non-relevant votes 871, the number of evidences extracted from the comments made on the submitted comments 872 and the screenshot associated with the evidences 874. The users can vote to establish if the validation of the statement is relevant or non-relevant 875. The average score between the relevant votes and the non-relevant votes is calculated 871 to provide the associated value 811. Comments with a hyperlink 876 that were made about the submitted statement provide a number of evidences 872 extracted from those comments and supporting the validation of the statement. More evidences in support of the validation of the statement increases the resulting value 877. The number of evidences 872 determines the associated value 811. The screenshots associated with the evidences 874 and displaying their content provides the associated value 811. More screenshots increase the resulting value 878.

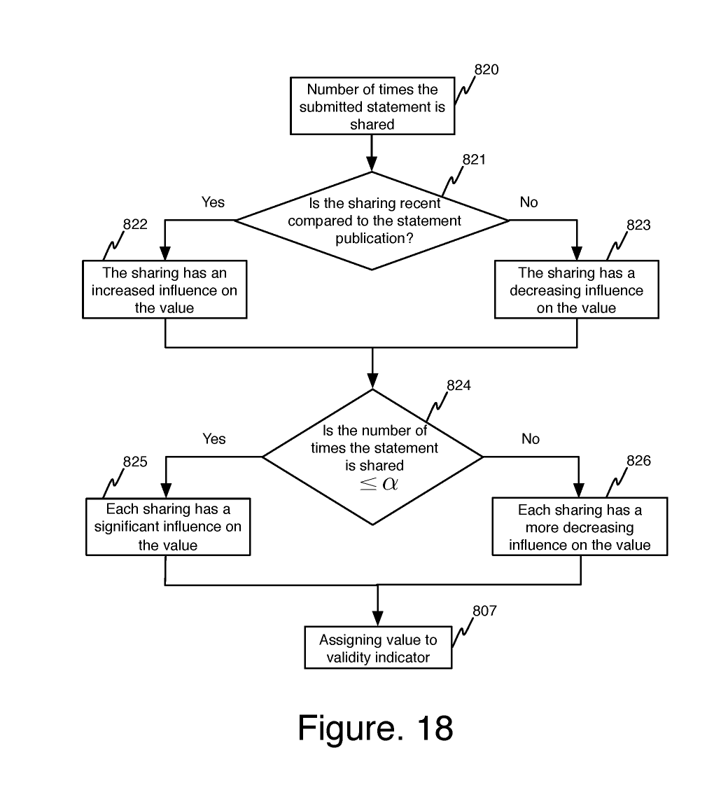

FIG. 18 illustrates the calculation of the value associated with the validity indicator based on the number of times the submitted statement is shared 820. A first test 821 is applied to determine if the sharing of the submitted statement is recent or not compared to the publication of the submitted statement. The more recent the sharing is the increased is its influence on the value 822. The less recent the sharing is, its influence on the value 823 is reduced. A second test 824 is applied to determine if the number of times the submitted statement is shared is inferior or equal to a value α. If the number of times the submitted statement is shared is inferior or equal to α, each sharing has an increased influence on the value 825. If the number of times the submitted statement is shared is superior to the value α, each sharing has a decreasing influence on the value 826. The tests 821 and 824 assign a value 807 to validity indicator 820. The more recent and the further from the value α a sharing is at the time it takes place the more influence it has in the calculation of value 807 associated with validity indicator 820. The less recent and the closest to value α a sharing is at the time it takes place and the less influence it has in the calculation of value 807 associated with validity indicator 820. The value α in the test 824 indicates the number of times the submitted statement is shared, beyond which each new sharing looses significant influence on the resulting value and every additional sharing will further decrease in influence to the point that assigned value 807 and validity indicator 820 will vary seldom.

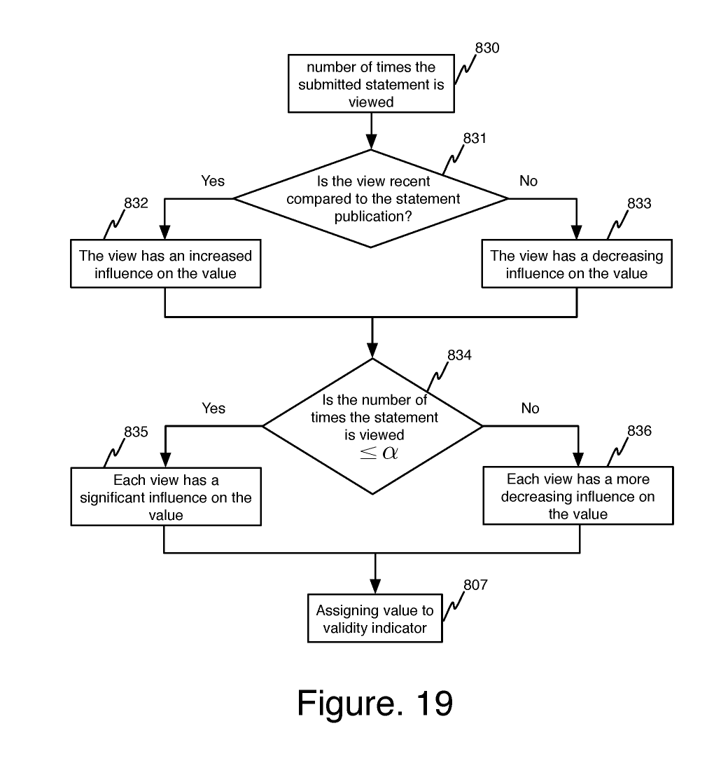

FIG. 19 illustrates the calculation of the value associated with the validity indicator based on the number of times the submitted statement is viewed 830. A first test 831 is applied to determine if the submitted statement has been recently viewed or not compared to the publication of the statement. The more recent the view is, its influence on the value 832 is increased. The less recent the view is, its influence on the value 833 is decreased. A second test 834 is applied to determine if the number of times the submitted statement is viewed is inferior or equal to a value α. If the number of times the submitted statement is viewed is inferior or equal to α, each view has a significant influence on the value 835. If the number of times the submitted statement is viewed is superior to the value α, each view has a decreasing influence on the value 836. The tests 831 and 834 assign a value 807 to validity indicator 830. The more recent and the further from the value α a view is at the time it takes place the more influence it has in the calculation of value 807 associated with validity indicator 820. The less recent and the closest to value α the statement is viewed and the less influence the viewing has in the calculation of value 807 associated with validity indicator 820. The value α in the test 834 indicates the number of times the submitted statement is viewed, beyond which each new view looses significant influence on the resulting value and every additional view will further decrease in influence to the point that assigned value 807 and validity indicator 820 will vary seldom.

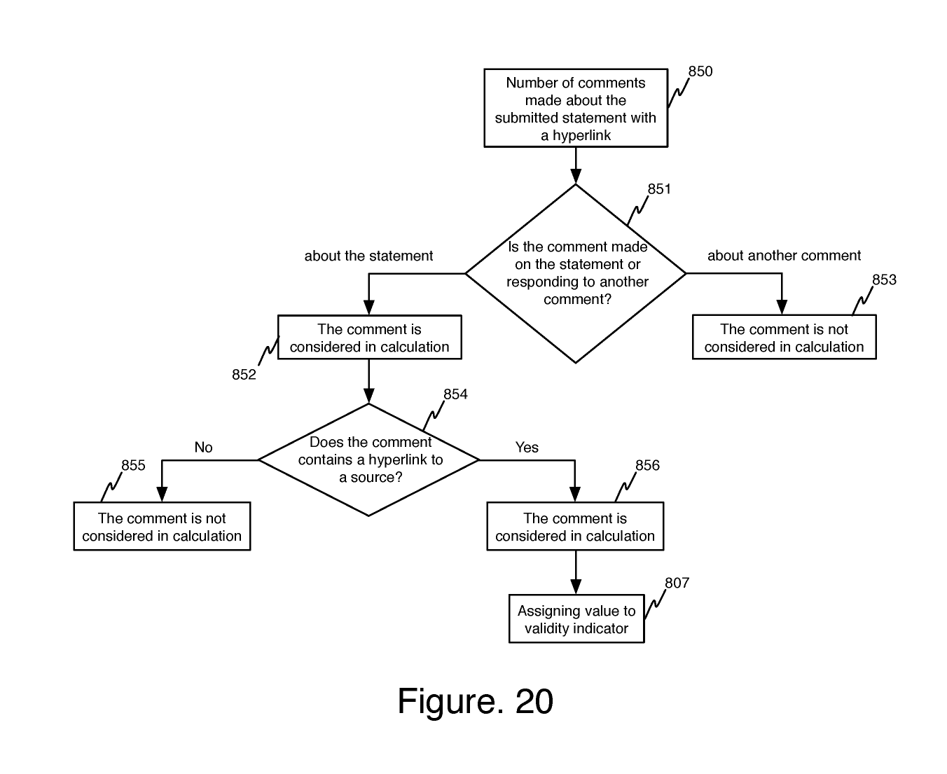

FIG. 20 illustrates the calculation of the value associated with the validity indicator based on the number of comments on the submitted statement 850. A first test 851 is applied to determine if the comment is made on the submitted statement or in response to a previous comment. If the comment is made about the statement 852, it is considered in the calculation. If the comment is made in response to another comment 853, it is not considered in the calculation and has a reduced or no influence on the value. A second test 854 is applied to determine if the comment about the statement contains a hyperlink to a source. If the comment does not contain a hyperlink to a source 855, it is not considered in the calculation and has no influence on the value. If the comment contains a hyperlink to a source 856, it is considered in the calculation increasing the value. The tests 851 and 854 assign a value 807 to the validity indicator 850

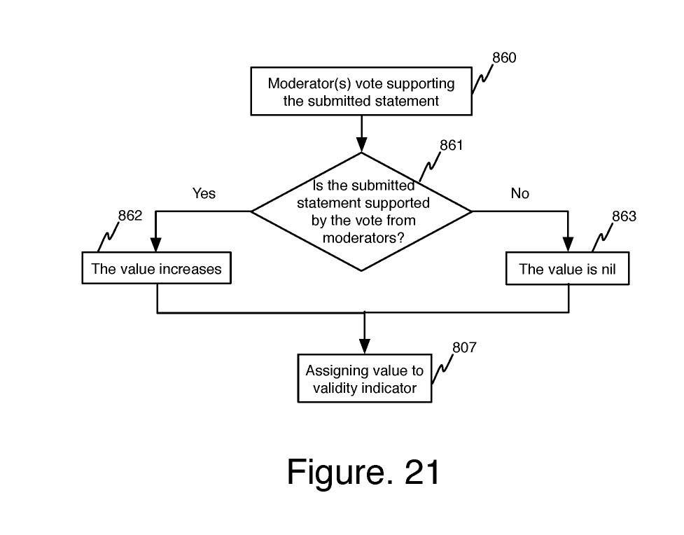

FIG. 21 illustrates the calculation of the value associated with validity indicator based on the number of moderators' votes supporting the submitted statement 860. A test 861 is applied to determine if the submitted statement is supported by the vote of a moderator. If one or more moderators vote 862 to support the submitted statement it increases the value. If no vote of a moderator supports the submitted statement, the resulting value is nil 863. The test 861 assigns a value 807 to the validity indicator 860.

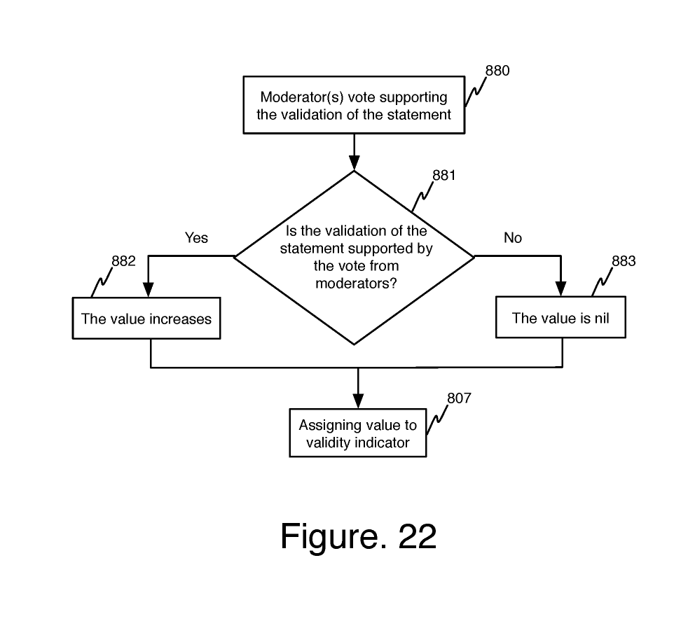

FIG. 22 illustrates the calculation of the value associated with validity indicator based on the number of moderators' votes supporting the validation of the statement 880. A test 881 is applied to determine if the submitted statement is endorsed by the vote of a moderator. If one or more moderators vote 882 to support the validation of the statement, the value is increased. If no vote of a moderator supports the validation of the statement, the resulting value is nil 883. The test 851 assigns a value 807 to the validity indicator 880.

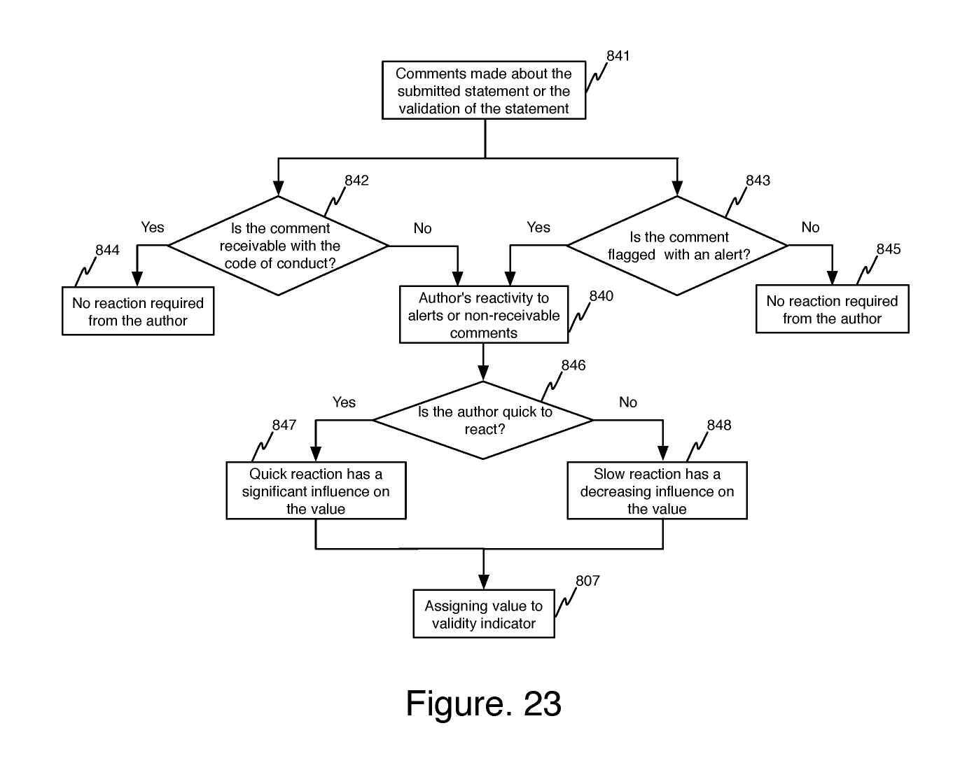

FIG. 23 illustrates the calculation of the value associated with validity indicator based on the author's reactivity to alerts or non-compliant comments 840. Comments are made about the submitted statement or validation statement 841. A first test 842 is applied to each comment to determine if the comment is receivable according to the code of conduct of the fact-checking network. A second test 843 is applied to determine if the comment is flagged with an alert. If the comment is receivable 844 no reaction from the author is required. If the comment is not flagged with an alert 845 no reaction from the author is required. If the comment is not receivable or flagged with an alert, the author's reactivity to alerts or non-compliant comments 840 is evaluated. A third test 846 is applied to determine if the author of the submitted statement or the validation of the statement is quick to react to the alert or non-receivable comment. If the author is quick to react 847 the reaction has a significant influence on the value. If the author is slow to react 848 the reaction has a decreasing influence on the value. The more reactive the author is the increasing the influence of the reaction on the value. The less reactive the author is the decreasing the influence of the reaction is on the value. The more time the authors takes to react, the more decreased the influence of the reaction is. Tests 842, 843 and 846 assign a value 807 associated with the validity indicator 840.

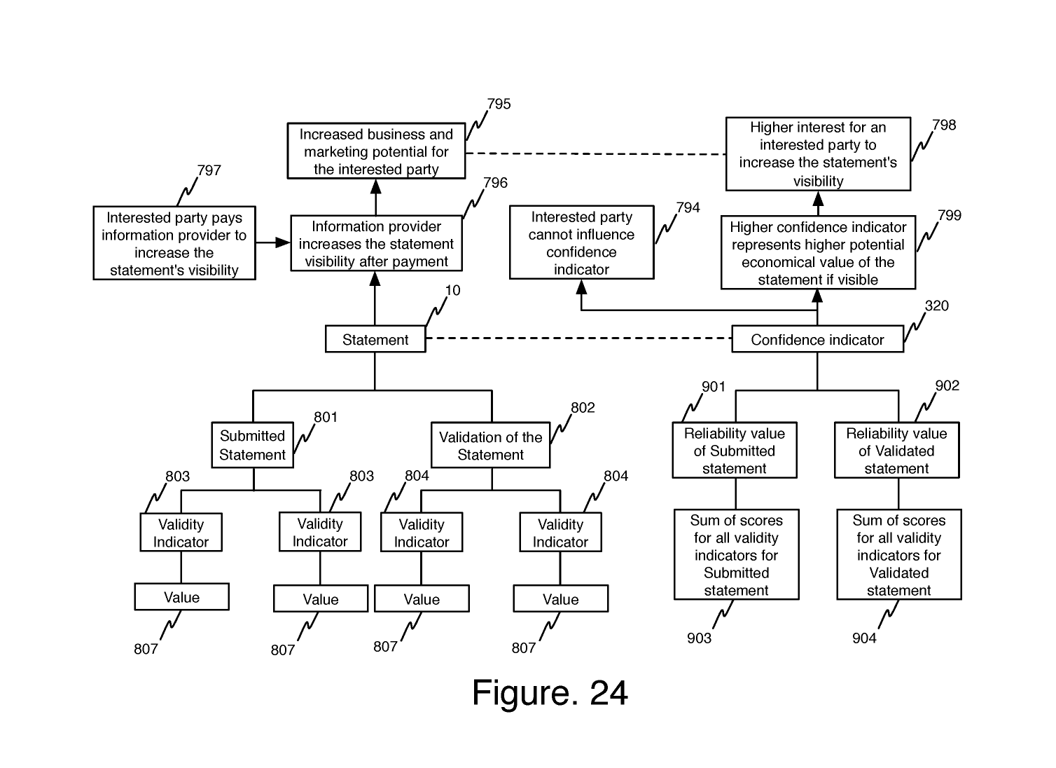

FIG. 24 is an illustration of the claimed method. A plurality of values 807 are associated with validity indicators 803 and 804, each validity indicator having its assigned value 807. The sum 903 of the values 807 associated with the validity indicators 803 associated to the submitted statement 801 provides the reliability value 901 of the submitted statement. The sum 904 of the values 807 associated with the validity indicators 804 associated to the validation of the statement 802 provides the reliability value 902 of the validation of the statement. The sum of the reliability value 901 of the submitted statement and the reliability value 902 of the validation of the statement are used to calculate the confidence indicator 320 associated to the statement 10. The confidence indicator 320 has a potential economical influence as a higher confidence indicator 799 represents a higher potential economical value of the statement if it is visible. A higher confidence indicator generates a higher interest 798 for an interested party to increase the statement's visibility. An interested party 797 pays the information provider to increase the statement's visibility. The information provider 796 increases the statement visibility after the payment. The increased visibility results in increased business and marketing potential for the interest party 795 consolidating the higher interest 798 to increase the statement's visibility. The method to assign the confidence indicator 320 to the statement 10 cannot be influenced by the interested party 794 preserving the confidence in the statement 10.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method of validating a statement in a fact checking system, the method comprising:
receiving a statement from an author via a computer interface displayed on a display of a computer;
receiving a plurality of comments associated with the statement from user via a computer interface displayed on a display of a computer;
receiving a plurality of votes associated with the statement from user via a computer interface displayed on a display of a computer;
validating the statement on a basis of a number of comments and a number of votes associated with the statement, validating the statement comprising
computing a first validity indicator associated with the plurality of comments; and
computing a second validity indicator associated with the plurality of votes, the method further comprising
computing a statement reliability value on a basis of a sum of the first validity indicator and the second validity indicator;
computing a statement validation reliability value on a basis of the second validity indicator; and
computing a statement confidence indicator on a basis of a sum of the statement reliability value and the statement validation reliability value, wherein the statement confidence indicator is used to validate the statement.

2. The method of claim 1, further comprising:
receiving a plurality of ratings of the content of the statement from a plurality of users made on a basis of votes relevance; and
computing a rating value of the content of the statement, the rating value of the content of the statement being used to rate the content of the statement.

3. The method of claim 1, further comprising:
receiving a plurality of evidences supporting the statement from a plurality of users; and
computing a value corresponding to a number of evidences supporting the statement, the value corresponding to the number of evidences supporting the statement being used to rate the statement.

4. The method of claim 1, further comprising:
receiving a plurality of screenshots associated with evidences supporting the statement; and
computing a value corresponding to a number of screenshots associated with the evidences supporting the statement, the value corresponding to the number of screenshots being used to rate the statement.

5. The method of claim 1, further comprising calculating a number of times the statement is shared, the number of times the statement is shared being used to provide a value corresponding to the number of times the statement is shared supporting the statement to rate the statement.

6. The method of claim 1, further comprising calculating a value corresponding to a number of times the statement is viewed, the value corresponding to the number of times the statement is viewed being used to rate the statement.

7. The method of claim 1, further comprising allowing an interested party to pay to increase a visibility of the statement;

8. The method of claim 1, further comprising electronically transferring an amount of money between an interested party and a bank account;

9. A non-transitory computer-readable medium having stored thereon computer-executable instructions that, when executed by a processor of a computer system, enable a method of validating a statement in a fact checking system, the method comprising:
receiving a statement from an author via a computer interface displayed on a display of a computer;
receiving a plurality of comments associated with the statement from user via a computer interface displayed on a display of a computer;
receiving a plurality of votes associated with the statement from user via a computer interface displayed on a display of a computer;
validating the statement on a basis of a number of comments and a number of votes associated with the statement, validating the statement comprising;
computing a first validity indicator associated with the plurality of comments; and
computing a second validity indicator associated with the plurality of votes, the method further comprising
computing a statement reliability value on a basis of a sum of the first validity indicator and the second validity indicator;
computing a statement validation reliability value on a basis of the second validity indicator; and
computing a statement confidence indicator on a basis of a sum of the statement reliability value and the statement validation reliability value, wherein the statement confidence indicator is used to validate the statement.

10. The non-transitory computer-readable medium of claim 9, further comprising:
receiving a plurality of ratings of the content of the statement from a plurality of users made on a basis of votes relevance; and
computing a rating value of the content of the statement, the rating value of the content of the statement, the value corresponding to the rating value of the content of the statement being used to rate the content of the statement.

11. The non-transitory computer-readable medium of claim 9, further comprising:
receiving a plurality of evidences supporting the statement from a plurality of users; and
computing a value corresponding to a number of evidences supporting the statement, the value corresponding to the number of evidences supporting the statement being used to rate the statement.

12. The non-transitory computer-readable medium of claim 9, further comprising:
receiving a plurality of screenshots associated with evidences supporting the statement; and
computing a value corresponding to a number of screenshots associated with the evidences supporting the statement, the value corresponding to the number of screenshots being used to rate the statement.

13. The non-transitory computer-readable medium of claim 9, further comprising allowing an interested party to pay to increase a visibility of the statement;

14. non-transitory computer-readable medium of claim 9, further comprising electronically transferring an amount of money between an interested party and a bank account;

15. A system comprising:
a computer power unit;
a memory operatively connected to the power unit; and
a display operatively connected to the power unit,
the system being configured to enable a method of validating a statement in a fact checking system,
the method comprising:
receiving a statement from an author via a computer interface displayed on a display of a computer;
receiving a plurality of comments associated with the statement from user via a computer interface displayed on a display of a computer;
receiving a plurality of votes associated with the statement from user via a computer interface displayed on a display of a computer;
validating the statement on a basis of a number of comments and a number of votes associated with the statement, validating the statement comprising;
computing a first validity indicator associated with the plurality of comments; and
computing a second validity indicator associated with the plurality of votes, the method further comprising
computing a statement reliability value on a basis of a sum of the first validity indicator and the second validity indicator;
computing a statement validation reliability value on a basis of the second validity indicator; and
computing a statement confidence indicator on a basis of a sum of the statement reliability value and the statement validation reliability value, wherein the statement confidence indicator is used to validate the statement.

16. The system of claim 15, further comprising:
receiving a plurality of ratings of the content of the statement from a plurality of users made on a basis of votes relevance; and
computing a rating value of the content of the statement, the rating value of the content of the statement being used to rate the content of the statement.

17. The system of claim 15, further comprising:
receiving a plurality of evidences supporting the statement from a plurality of users; and
computing a value corresponding to a number of evidences supporting the statement, the value corresponding to the number of evidences supporting the statement being used to rate the statement.

18. The system of claim 15, further comprising:
receiving a plurality of screenshots associated with evidences supporting the statement; and
computing a value corresponding to a number of screenshots associated with the evidences supporting the statement, the value corresponding to the number of screenshots being used to rate the statement.

19. The system of claim 15, further comprising allowing an interested party to pay to increase a visibility of the statement;

20. The system of claim 15, further comprising electronically transferring an amount of money between an interested party and a bank account;
